(19) United States
(12) Patent Application Publication
(10) Pub. No.: US 2017/0137717 A1
(43) Pub. Date: May 18, 2017

(54) COMPOSITION AND METHOD OF USE OF VTAE

(71) Applicant: Kleen Performance Products, Inc., Richardson, TX (US)

(72) Inventors: William Allen Palmer, Broken Arrow, OK (US); Mark G. Bouldin, Frisco, TX (US); Kenneth Francis Gryzbowski, Temple Terrace, FL (US); Stephen Carey Lewis, Winfield, IL (US); Jean-Valery Martin, Tampa, FL (US)

(21) Appl. No.: 15/354,026

(22) Filed: Nov. 17, 2016

Related U.S. Application Data
(60) Provisional application No. 62/256,549, filed on Nov. 17, 2015.
(60) Provisional application No. 62/289,166, filed on Jan. 29, 2016.
(60) Provisional application No. 62/407,874, filed on Oct. 13, 2016.

(51) Int. Cl. C10C 3/00; C08L 95/00; C04B 24/26; C04B 14/28; C10L 1/04; C04B 26/26

(52) U.S. Cl. CPC C10C 3/00; C10L 1/04; C04B 26/26; C04B 24/2676; C04B 14/28; C08L 95/00; C10L 2270/04; C10L 2290/547; C10L 2290/24; C04B 2111/00586

(57) ABSTRACT

The present invention generally relates to a process for purifying vacuum tower asphalt extender (VTAE), from re-refined lubricants, or generally recycled oil via solvent treatment to afford a purified material from certain components with improved benefits for use for instance with petroleum products.

### RELATED APPLICATIONS AND INCORPORATION BY REFERENCE

This application claims the benefit of and priority to U.S. Provisional Application Nos. 62/256,549 filed Nov. 17, 2015; 62/289,166 filed Jan. 29, 2016; and 62/407,874 filed Oct. 13, 2016.

The foregoing applications, and all documents cited therein or during their prosecution (“appin cited documents”) and all documents cited or referenced in the appin cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. More specifically, all referenced documents are incorporated by reference to the same extent as if each individual document was specifically and individually indicated to be incorporated by reference.

### FIELD OF THE INVENTION

The present invention generally relates to a process for purifying the vacuum tower bottoms (e.g., vacuum tower asphalt extender (VTAE)) of re-refined engine oil, lubricants, or generally recycled oil via solvent treatment to afford a purified material from certain components with improved benefits for use for instance with petroleum products. The present invention also generally relates to formulations using a VTAE or re-refined engine oil bottom (REOB) and other lubricating oils in a composition of polymer modified Asphalt or bitumen directed to construction materials for waterproofing, sealing and/or otherwise covering construction surfaces and the method of manufacturing and using such compositions.

### BACKGROUND OF THE INVENTION

Generally, bitumen is a viscous, black and sticky organic liquid that may be soluble in carbon disulfide. Bitumen are a class of amorphous, solid, semi-solid or viscous, cementitious substances, natural or manufactured, composed generally without limitation of high molecular weight hydrocarbons, as typically found in asphalts, tars, pitches and asphaltites. Bituminous materials are typically derived from asphalt or coal tar, with asphalt found naturally or attainable as a by-product of crude oil refining, and coal tar and pitches produced by the destructive distillation of coal. In some instances, bituminous materials, such as asphalt, can comprise bitumen and at least one other substance, such as an additive. The compositional make up of coal, coal tar pitches, crude oils and natural asphalts vary depending upon the geological origin and/or geographical source. As a result, the physical characteristics of any one bituminous material, whether natural or manufactured, can differ markedly from another. The varieties of bitumens give it wide utility in the building and construction industry.

As known to those skilled in the art the terms bitumen and bituminous can refer generically to various asphalts, coal tars, pitches and the like. However as it is also understood that outside North America and, particularly, the United States, the term “bitumen” is applied generically to mean other asphalt materials. The compositions of this invention include those comprising the high molecular weight hydrocarbons which predominate and are found in asphalts, coal tars, pitches, asphaltites and the like, notwithstanding any difference in generic nomenclature. Accordingly, the bitumen component of the inventive compositions described herein can be drawn, without limitation, from various known sources of asphalt, coal, tar, and coal tar pitches, whether neat, dissolved, emulsified, or polymer modified.

In the petroleum family, asphalts are available from refining and naturally occurring sources. Asphalts are thermoplastic materials widely used in the infrastructure and construction products industries. Asphaltic materials are also sensitive to oxidative aging causing embrittlement, which reduces the available service life and ultimately contributes to failure of the material. Used engine oil, and other lubricants (lubricating oils), typically contain an array of impurities related to their exposures to certain conditions during their usage (e.g., metals, solid particles, additives of various nature, products of oxidation, etc.). The common process for re-refining of recovered lubricating oils (Safety-Kleen process for instance) produces a residual material collected in the Vacuum Distillation Bottoms (VDBs) which concentrates the impurities (e.g., metals, particles, etc.). Used oils are collected and screened for re-refining suitability. In the first processing step, the oil is dehydrated to remove water and any light volatiles that are recovered. The second step typically involves a combination of atmospheric and vacuum distillation to separate the lighter portion, or lube cut, of the recycled stream from the heavy oils and the impurities, which are referred to as VTAE. The final step of re-refining is to fractionate remaining lube cut into different grades (Wielinski, J. C. et al. “The Impact of Asphalt Blended with RE-refined Vacuum Tower Bottoms (RVTB) and Its Effect on HMA Mixture Performance” Canadian Technical Asphalt Association 2014).

When used in the asphalt industry the vacuum distillation bottoms are commonly referred to as Vacuum Tower Asphalt Extender (VTAE). Recent research (Rubab, S., et al. “Effects of Engine Oil Residue on Asphalt Cement Quality,” Proceedings, Canadian Technical Asphalt Association, 56, 2-12 (2011)) suggests that EOR (or VTAE) increases oxidations in asphalts due to the presence of metal catalysts and oxidized engine components. The authors claim that higher oxidation rates results in more rapid gelation which increases restraining stress during winter causing premature fatigue and thermal cracking. These impurities limit the use of the VTAE to certain applications as well as certain dosage levels within the various applications. For these reasons, it is desirable to purify the VTAE even further. Moreover, it is possible to reduce, retard or prevent aging of asphaltic materials by means of combining these materials with a further purified VTAE beyond the level that is generated in the standard Safety-Kleen re-refining process.

There has been an increased demand in the highway paving industry for softer grade asphalt binders such as PG 58-28, 52-34, etc. This is primarily due to owner agencies allowing higher amounts of recycled pavement and roofing shingles in HMA mixtures. These recycled materials contain highly oxidized and brittle asphalt requiring that softer grades of additional asphalt be used to create an acceptable finished asphalt blend. In the roofing industry, finding and sourcing single source-derived asphalt fluxes has become increasingly more difficult due to current refinery operations and economics. Furthermore, finding available fluxes which meet the stringent requirements of the roofing industry are equally scarce. Refineries have exhibited an overall reluctance to revise current crude sourcing and refinery processing to produce a suitable flux with qualities which will yield an air blown coating compliant with specifications

The performance required of any such bituminous material is determined by its end use and/or application and is gauged by one or more measurable properties. A bitumen used in the fabrication of a roofing product can be defined by its softening point, penetration, flash point, viscosity-temperature relationship, among other such performance properties. A bitumen used in roadway paving applications can be defined by its ability to relax thermal stresses, resist fatigue cracking and resist permanent deformation at high temperatures under traffic loading, among other properties.

There are many applications for bitumen and/or various asphalt compositions. For example, they can be used for waterproofing products or articles, such as roofs, foundations, buildings, boats, shingles, roofing felts, roofing sheets or roofing membranes, as well as for paving roads, rail beds, runways, running tracks, greenway trails, playgrounds, bicycle and golf cart paths, racetracks, basketball and tennis courts, driveways, subdivision roads, animal feed lots, poultry house floors, barn floors, greenhouse floors, work sites, log yards, ports, freight yards, landfill caps and the like. Furthermore, bitumen and various asphalt compositions can be used in fish hatcheries, reservoir liners, industrial retention ponds, sea walls, dikes and groins.

Bitumen and asphalt can be modified chemically or physically for various applications, each of which requires certain desirable properties. For example, modified bitumen (MB) is bitumen modified by additives to give it plastic or rubber-like properties. Some modified bitumen sheets or membranes can be used in low slope roofing for commercial and large buildings. Modified bitumen may also be utilized in roofing sheets or waterproofing membranes.

In the roofing industry, these improvements would exhibit efficacy in both the steep and low slope roofing sectors, typical product types are: built-up roofing mopping asphalt, ply and cap sheets, shingles, rolled roofing products, and components of shingles such as tab sealants and laminating adhesives.

Asphalt shingles are generally the primary roofing materials for residential graded roofs. Asphalt shingles may comprise either organic felt materials or glass fiber reinforcing mats which are saturated or encapsulated with bitumen or asphalt to make them waterproof. In general, asphalt shingles are for steep slope roofing whereas modified bitumen membranes are for low slope roofing.

The overall performance of a roofing composition depends upon the properties of the various components, as well as their interaction and interdependence upon one another. For example, coating asphalts are often reinforced with a mineral stabilizer/filler such as ground limestone, slate, or traprock. The stabilizer/filler enhances asphalt durability and increases resistance to fire and weathering. Depending upon the specific physical and/or performance requirements, such asphalt materials can be incorporated into any one of a number of residential and commercial roofing products, including shingles, rolled roofing, underlayments and various membranes.

Waterproofing membranes are commonly used in the roofing industry. It is also well known to use bituminous compositions to manufacture waterproofing materials that are generally used for roof covering and roofing underlayments.

In manufacturing the modified asphalt binder compositions, polymer is introduced with molten asphalt. Under sufficient conditions of mixing and/or shear, the polymer is dissolved and/or dispersed into the molten-asphalt composition. It is desirable to uniformly disperse the polymer throughout the composition. Certain polymers, such as styrene-butadiene-styrene block polymers do not disperse as efficiently into the molten asphalt. As a result, the addition of compatibilizing agent are very often required to achieve a desirable dispersion of the polymer within the asphalt. Conventional approaches to improving the dispersibility of the polymers into the molten asphalt includes the use of aromatic oils (i.e., petroleum extracts.) However, these oils present a number of undesirable features such as their carcinogenicity, toxicity to reproduction and high cost.

Attempts have been made to mix bitumen and asphalt with a wide range of polymers for various applications including roofing and paving. Such polymers include atactic polypropylene (APP) and styrene block copolymers (SBS) (e.g., styrene-butadiene-styrene (SBS), styrene-isoprene-styrene (SIS), and styrene-ethylene-butadiene-styrene block copolymers (SEBS)). The polymers typically used contain a diene monomer or unsaturated site. Typically these include block copolymers of styrene and butadiene (SB or SBS); random copolymers of styrene and butadiene (styrene-butadiene rubber or SBR); copolymers of ethylene, propylene, and at least one diene monomer (EPDM); butyl rubbers; or any other suitable polymer having at least one unsaturated bond; plastomers such as ethylene vinyl acetate (EVA); ethylene methacrylate (EMA); ethylene butyl acrylate (EBA); polyethylene (PE); ethylene glycidyl methacrylate (EGMA); and the mixtures thereof. The weight percent of polymer in the total polymer modified asphalt binder should be an effective amount based on the desired physical properties of the resulting road paving or roofing asphaltic binder composition and may be any suitable amount greater than zero to about 25 wt %. The upper limit is often constrained by the cost of the polymer added, as well as by physical properties of the product. For asphaltic binder compositions used in paving application, too high of a polymer content could lead to excessive viscosity at the operating temperatures making binder difficult to work with.

Thus, there is a need to improve the dispersibility of polymers, without deleteriously sacrificing performance.

As opposed to aromatic oil from petroleum extract, VTAE are not carcinogenic, exhibit significantly higher flash point (from 250° C. to 300° C.) and are markedly more economical to use.

Mineral fillers, as used herein, refer to mineral fine particle with physical size passing the 200-mesh sieve. These include but are not limited to limestone filler, ceramic waste, coal fly ash, quartz, kaolin, steel slag, and mixtures thereof. (R. Muniandy, Eltaher Aburkaba, R. Yunus, H. Hamid and H. Salihudin, 2012. Influence of Mineral Filler Particle Size and Type on Rheological and Performance Properties of SMA Asphalt-filler Mastics. Asian Journal of Applied Sciences, 5: 522-537.)

Modifiers or synthetic, pressure sensitive adhesives include butyl rubber based adhesives, polyisobutylene based adhesives, butyl based adhesives, acrylic based adhesives, vinyl ether based adhesives, styrene-isoprene-styrene (SIS) based adhesives, styrene-ethylene-butylene-styrene (SEBS) based adhesives, styrene-butadiene-styrene (SBS) based adhesives, styrene-butadiene rubber (SBR) based adhesives, and combinations thereof. Preferably, the synthetic adhesive is a pressure sensitive hot melt adhesive block copolymer of SIS, SBS or SEBS, most preferably SIS block copolymer. For a more detailed description of pressure sensitive adhesives, see Satas, Handbook Of Pressure Sensitive Adhesive Technology, by Van Nostrand Reinhold Company, Inc. (1982), incorporated herein by reference. Other rubbers include polyisoprene, polybutadiene, natural rubber, polychloroprene rubber, ethylene-propylene rubber, ethylene alpha olefin, nitrile rubbers, and acrylic rubber. Other suitable synthetic pressure sensitive adhesives may comprise amorphous polyolefins. Amorphous polyolefin (APO) is defined as polyolefin with a degree of crystallinity of less than 30% as measured by differential scanning calorimetry. These polymers can be either homopolymers of propylene or copolymers of propylene with one or more alpha-olefin comonomer, such as, for example, ethylene, 1-butene, 1-hexene, 1-octene and 1-decene. The APO polymers of the types herein described above are commercially available from Eastman Chemical Company, Kingsport, Tenn., under the trade name designation Eastoflex or from Huntsman Corporation, Houston, Tex., under the trade name designation Rextac or from Degussa Corporation, Parsipanny, N.J., under the trade name designation Vestoplast. Like rubber based adhesives, these are also combined with a tackifier and plasticizer to produce a pressure sensitive adhesive. See Eastman bulletin “Pressure-Sensitive Adhesives Based on Amorphous Polyolefin From Eastman Chemical Company.”

Citation or identification of any document in this application is not an admission that such document is available as prior art to the present invention.

### SUMMARY OF THE INVENTION

The present invention relates in part to a process for purifying the vacuum tower bottoms (i.e., vacuum tower asphalt extender (VTAE)) of re-refined engine oil, lubricants, or generally recycled oil via distillation, either through atmospheric distillation or vacuum distillation or a combination of both, to afford a purified material from certain components with improved benefits for use for instance with petroleum products. The present invention also relates to a formulation using a VTAE or re-refined engine oil bottom (REOB), and or other lubricating oils, in a composition directed to construction materials for waterproofing, sealing and/or otherwise covering construction surfaces and the method of manufacturing and using such compositions.

The invention provides a process of purifying Vacuum Tower Asphalt Extender (VTAE) comprising (a) contacting the VTAE with a hydrocarbon solvent or a hydrocarbon solvent mixture thereof; (b) precipitating a mixture of solid materials with the solvent or solvent mixture; (c) filtering the mixture of solid materials and filtrate; (d) concentrating the filtrate whereby the purified VTAE is obtained; wherein the hydrocarbon solvent or hydrocarbon solvent mixture thereof is able to be recycled back into contacting the VTAE with a hydrocarbon solvent or a hydrocarbon solvent mixture thereof.

In an embodiment of the invention although a hydrocarbon solvent is used, any number of organic solvents can be used to precipitate out the metals and other solids from the VTAE. Purified VTAE contains no wax and there are no naphthalene or naphthalene derivatives in the components. Thus, any number of solvents which can precipitate out metals and other solids from the VTAE can be used. In a further embodiment, the hydrocarbon solvent is at least one petroleum-derived hydrocarbon solvent. In an embodiment of the invention, the hydrocarbon solvent mixture is at least two solvents selected from the group consisting of pentane, hexane, n-pentane, n-heptane. In a further embodiment, the hydrocarbon solvent is selected from the group consisting of pentane, hexane, n-pentane, n-heptane.

In another aspect of the invention, the invention provides a process of combining about 1% purified VTAE with about 99% asphalt or bitumen which comprises applying a controlled flow of air through the material at a temperature range from 300° F. to 600° F. In an embodiment of the invention, the process provides a blend of about 5% purified VTAE to about 95% asphalt or bitumen. In an embodiment of the invention, the process provides a blend of about 10% purified VTAE to about 90% asphalt or bitumen. In a further embodiment, the process provides a blend of about 20% purified VTAE to about 80% asphalt or bitumen. In an embodiment of the invention, the process provides a blend of about 30% purified VTAE to about 70% asphalt or bitumen. In another embodiment of the invention, the process provides a blend of about 40% purified VTAE to about 60% asphalt or bitumen. In an embodiment of the invention, the process provides a blend of about 50% purified VTAE to about 50% asphalt or bitumen. In another embodiment of the invention, the process provides a blend of about 60% purified VTAE to about 40% asphalt or bitumen. In a further embodiment of the invention, the process provides a blend of about 70% purified VTAE to about 30% asphalt or bitumen. In an embodiment of the invention, the process provides a blend of about 80% purified VTAE to about 20% asphalt or bitumen. In a further embodiment of the invention, the process provides a blend of about 90% purified VTAE to about 10% asphalt or bitumen.

In a related aspect of the invention the process is directed to combining purified VTAE with asphalt or bitumen at a temperature range from 350° F. to 500° F. In a further embodiment of the invention, the process is directed to combining purified VTAE with asphalt or bitumen at a temperature range from 375° F. to 450° F. In an embodiment of the invention, the process is directed to combining purified VTAE with asphalt or bitumen at a temperature range from 395° F. to 425° F.

In a related aspect, the invention relates to a process for purifying the vacuum tower bottoms (i.e., vacuum tower asphalt extender (VTAE)) of re-refined engine oil, lubricants, or generally recycled oil via solvent treatment followed by a further distillation to afford a purified material from certain components with improved benefits for use for instance with petroleum products.

The invention is directed to a process for purifying Vacuum Tower Asphalt Extender (VTAE) comprising distilling the VTAE under atmospheric and reduced atmospheric conditions to afford a heavy vacuum gas oil (HVGO), a purified material from certain components with improved benefits for use.

The invention provides a composition comprising an improved heavy vacuum gas oil (HVGO) the improvement comprising reduced aging and oxidation of asphaltic materials wherein the metals selected from the group consisting of aluminum, barium, boron, cadmium, calcium, chromium, copper, iron, lead, molybdenum, manganese, magnesium, nickel, phosphorous, silver, sodium, tin, titanium, vanadium, and zinc is reduced by 95% or better. In an embodiment of the invention the composition comprises metals selected from the group consisting of aluminum, barium, boron, cadmium, calcium, chromium, copper, iron, lead, molybdenum, manganese, magnesium, nickel, phosphorous, silver, sodium, tin, titanium, vanadium, and zinc below a detectable limit.

In an a related aspect of the invention, the present application provides a blend or a fuel blend comprising a composition of a heavy vacuum gas oil, wherein the ratio of HVGO to other fuel blending components is in the amount of 1:99 to 99:1 by volume.

In an embodiment of the invention, the composition provides a blend of about 5% HVGO to about 95% other fuel blending components by volume. Blends or fuel blends are specified by molar gas fraction (e.g., volumetric gas fraction), by percentage, parts per thousand, parts per million, or mass fraction. Generally, fuel blending components may include, but are not limited to, asphalt, base oils from lubricants, vacuum gas oil, coker gas oils, cutter stocks, extract oils, transmix blends, marine diesel, fuel oils, biodiesel, biofuel, FCCU (fluid catalytic cracking unit) gasoline, Reformate, T-X blend stocks, specialty gasoline blend stocks, cycle oil, kerosene, diesel blend stocks, petroleum-based products or anything combustible which has a BTU value.

In an embodiment of the invention, the composition provides a blend of about 10% HVGO to about 90% other fuel blending components by volume. In a further embodiment, the composition provides a blend of about 20% HVGO to about 80% other fuel blending components by volume. In an embodiment of the invention, the composition provides a blend of about 30% HVGO to about 70% other fuel blending components by volume. In another embodiment of the invention, the composition provides a blend of about 40% HVGO to about 60% other fuel blending components by volume. In an embodiment of the invention, the composition provides a blend of about 50% HVGO to about 50% other fuel blending components by volume. In another embodiment of the invention, the composition provides a blend of about 60% HVGO to about 40% other fuel blending components by volume. In a further embodiment of the invention, the composition provides a blend of about 70% HVGO to about 30% other fuel blending components by volume. In an embodiment of the invention, the composition provides a blend of about 80% HVGO to about 20% other fuel blending components by volume. In a further embodiment of the invention, the composition provides a blend of about 90% HVGO to about 10% other fuel blending components by volume. In an embodiment of the invention, the composition provides a blend of about 95% HVGO to about 5% other fuel blending components by volume.

In another aspect of the invention, the present application provides a fuel blend comprising a composition of a heavy vacuum gas oil, wherein the ratio of HVGO to other fuel blending components is in the amount of 1:99 to 99:1 by weight. In an embodiment of the invention, the composition provides a blend of about 5% HVGO to about 95% other fuel blending components by weight. In an embodiment of the invention, the composition provides a blend of about 10% HVGO to about 90% other fuel blending components by weight. In a further embodiment, the composition provides a blend of about 20% HVGO to about 80% other fuel blending components by weight. In an embodiment of the invention, the composition provides a blend of about 30% HVGO to about 70% other fuel blending components by weight. In another embodiment of the invention, the composition provides a blend of about 40% HVGO to about 60% other fuel blending components by weight. In an embodiment of the invention, the composition provides a blend of about 50% HVGO to about 50% other fuel blending components by weight. In another embodiment of the invention, the composition provides a blend of about 60% HVGO to about 40% other fuel blending components by weight. In a further embodiment of the invention, the composition provides a blend of about 70% HVGO to about 30% other fuel blending components by weight. In an embodiment of the invention, the composition provides a blend of about 80% HVGO to about 20% other fuel blending components by weight. In a further embodiment of the invention, the composition provides a blend of about 90% HVGO to about 10% other fuel blending components by weight. In an embodiment of the invention, the composition provides a blend of about 95% HVGO to about 5% other fuel blending components by weight.

In another aspect of the invention, Applicants provide a method of improving the performance of roofing asphalt comprising a blend of a HVGO composition wherein the metals selected from the group consisting of aluminum, barium, boron, cadmium, calcium, chromium, copper, iron, lead, molybdenum, manganese, magnesium, nickel, phosphorous, silver, sodium, tin, titanium, vanadium, and zinc is reduced by 80% or better. In an embodiment, Applicants provide a method of improving the performance of roofing asphalt comprising a blend of a HVGO composition wherein the metals selected from the group consisting of aluminum, barium, boron, cadmium, calcium, chromium, copper, iron, lead, molybdenum, manganese, magnesium, nickel, phosphorous, silver, sodium, tin, titanium, vanadium, and zinc are below a detectable limit.

The invention provides a method of operating a marine vessel turbine with a fuel blend having from about 0.1% to about 99.9% of heavy vacuum gas oil, the method comprising providing a HVGO and other component blend composition with a sulfur content of less than about 0.05 ppm; mixing the HVGO composition with a natural gas, wherein the mixture provides a fuel oil; and, utilizing the fuel oil to generate heat or pressure to drive an engine or a gas turbine.

In an another aspect of the invention, the invention provides a method of manufacturing industrial products utilizing a process oil blend having from about 0.1% to about 99% of heavy vacuum gas oil, the method comprising providing a heavy vacuum gas oil composition with a low ash content; mixing the heavy vacuum gas oil composition with a base process oil; and, introducing the process oil blend into an industrial product.

In another aspect of the invention, the application provides a material combining a series of properties suitable for a large number of applications such as but not limited to self-adhesive formulation for use in construction. An aspect of the invention provides a polymer modified asphalt or bitumen formulation comprising about 1-98% by weight of a base asphalt or bitumen; about 1-30% by weight of a VTAE; about 1-30% by weight of at least one or more bituminous modifier selected from the group consisting of atactic polypropylene, styrene-butadiene-sytrene (SBS), styrene-butadiene rubber (SBR), styrene-ethylene-butadiene-sytrene (SEBS), styrene-isoprene-styrene (SIBS), ethylene vinyl acetate, ethylene methacrylate, ethylene butyl acrylate, polyethylene (PE); ethylene glycidyl methacrylate (EGMA) butyl rubber, and mixtures thereof; optionally a self-adhesive bituminous material selected from the group consisting of a tackifying resin, pressure sensitive adhesive, and polyvinylbutyral polymer; and, optionally at least one or more mineral filler selected from the group consisting of limestone filler, talc, volcanic ash, graphite, carbon black, silica or china clay, quartz, coal fly ash, kaolin, steel slag, and mixtures thereof. In an embodiment, the bitumen modifier comprises a thermoplastic polymer or a mixture of thermoplastic polymers. In another embodiment, the base asphalt or bitumen ranges about 45-95% by weight. In an embodiment, the base asphalt or bitumen ranges about 50-90% by weight. In an embodiment, the base asphalt or bitumen ranges about 60-80% by weight. In a further embodiment, the base asphalt or bitumen ranges about 65-75% by weight.

In an aspect of the invention the polymer modified asphalt or bitumen formulation comprises at least one or more bituminous modifiers. In an embodiment the bituminous modifier comprises at least one modifier which includes, but is not limited to, atactic polypropylene, styrene-butadiene-sytrene (SBS), styrene-ethylene-butadiene-sytrene (SEBS), styrene-isoprene-styrene (SIBS), ethylene vinyl acetate, ethylene methacrylate, ethylene butyl acrylate, polyethylene (PE); ethylene glycidyl methacrylate (EGMA) butyl rubber, and mixtures thereof. In a further aspect, the bituminous modifier comprises at least one modifier comprising styrene-butadiene-styrene (SBS), styrene-ethylene-butadiene-styrene (SEBS), styrene-isoprene-styrene (SIBS), butyl rubber, chemical additives such as polymer cross-linkers, polyphosphoric acid, anti stripping agents, and mixtures thereof.

In an embodiment, polymer cross-linkers may include, but are not limited to elemental sulfur, hydrocarbyl polysulfides, thiurams, dithiocarbamates, sulfur containing oxazoles, thiazole derivatives, sulfur-donor vulcanization accelerators, non-sulfur donor vulcanization accelerators, phenolic resins, peroxides, selenium, and mixtures thereof. The amount of polymer cross-linkers ranges from about 0.01% by weight to about 5.0% by weight.

In a further embodiment, polymers may be crosslinked by an acid, wherein the acid may include, but is not limited to, phosphoric acid, polyphosphoric acid, sulfuric acid, chlorosulfuric acid, hydrohalic acids, nitric acid, organosulfuric acids, boric acid, carboxylic acids, alkylbenzenesulfonic acids, alkylsulfonic aicds, and mixtures thereof. In an embodiment, the acid comprises from about 0.01% by weight to about 3.0% by weight of the cross-linked polymer modified asphalt.

In another embodiment, the self-adhesive roofing formulation comprises at least one or more bituminous modifier which ranges about 1-10% by weight. In a further aspect, the bituminous modifier ranges from about 1-7% by weight. In another embodiment, the bituminous modifier ranges from 1-7% by weight. In a further embodiment, the bituminous modifier ranges from 1-5% by weight.

In an embodiment, at least one or more mineral filler is selected from the group consisting of limestone filler, talc, volcanic ash, graphite, carbon black, silica or china clay, quartz, coal fly ash, kaolin, steel slag, and mixtures thereof.

The present application also provides a method of manufacturing a polymer modified asphalt or bitumen formulation comprising: (a) provide a base asphalt; (b) admixing VTAE; (c) adding at least one or more bituminous modifier; (e) optionally adding a cross-linker, wherein the crosslinker enhances the properties of the bituminous modifier, (f) optionally adding a chemical additive, wherein the chemical additive improves adhesion and or compatibility of the bituminous modifier, (g) optionally adding a self-adhesive resin; and, (h) optionally adding a mineral filler. In an embodiment, the base asphalt of step (a) is heated to a temperature range from about 100° C. to about 250° C. In a further embodiment of the method, the base asphalt of step (a) is heated to a temperature range from about 135° C. to about 200° C. In an embodiment of the invention, the VTAE is pre-heated. The admixed VTAE is pre-heated to a consistency suitable to ensure pump-ability and acceptable blending ability with the provided asphalt. In an aspect of the embodiment, the consistency suitable to ensure pump-ability may be indicated by a viscosity range from about 3 Pa·s to about 5 Pa·s at 200° C.

In an aspect of the invention, the crosslinker or polymer crosslinker enhances the properties of the bituminous modifier with respect to dispersion, stability, stiffness, and processability.

In another aspect, adhesion refers to surface adhesion of granules or of modified material which is layered on a surface such as below grade concrete walls.

In an embodiment of the method of manufacturing a self-adhesive roofing formulation, the bituminous modifier includes at least one of the following: atactic polypropylene, styrene-butadiene-sytrene (SBS), styrene-ethylene-butadiene-sytrene (SEBS), styrene-isoprene-styrene (SIBS), ethylene vinyl acetate, ethylene methacrylate, ethylene butyl acrylate, polyethylene (PE); ethylene glycidyl methacrylate (EGMA) butyl rubber, chemical additives such as polymer cross-linkers, polyphosphoric acid, antistripping agents, and mixtures thereof. In a further aspect, the bituminous modifier comprises at least one modifier comprising styrene-butadiene-styrene (SBS), styrene-ethylene-butadiene-styrene (SEBS), styrene-isoprene-styrene (SIBS), butyl rubber, and mixtures thereof.

In an embodiment of the method of manufacturing a polymer modified asphalt or bitumen formulation, the self-adhesive bituminous material includes, but is not limited to, a tackifying resin, pressure sensitive adhesive, and polyvinylbutyral polymer.

In an embodiment of the method of manufacturing a polymer modified asphalt or bitumen formulation, the mineral filler includes, but is not limited to, limestone filler, talc, volcanic ash, graphite, carbon black, silica or china clay, quartz, coal fly ash, kaolin, steel slag, and mixtures thereof.

In a related aspect of the invention, the present application provides a method of improving the performance of a polymer modified asphalt or bitumen formulation comprising a composition comprising VTAE, asphalt or bitumen, at least one or more bituminous modifier, a self-adhesive bituminous material, and a mineral filler. In an embodiment, the bituminous modifier includes, but is not limited to, atactic polypropylene, styrene-butadiene-sytrene (SBS), styrene-ethylene-butadiene-sytrene (SEBS), styrene-isoprene-styrene (SIBS), ethylene vinyl acetate, ethylene methacrylate, ethylene butyl acrylate, polyethylene (PE); ethylene glycidyl methacrylate (EGMA) butyl rubber, and mixtures thereof. In a further aspect, the bituminous modifier comprises at least one modifier comprising styrene-butadiene-styrene (SBS), styrene-ethylene-butadiene-styrene (SEBS), styrene-isoprene-styrene (SIBS), butyl rubber, and mixtures thereof. In another embodiment, bituminous material includes, but is not limited to, a tackifying resin, pressure sensitive adhesive, and polyvinylbutyral polymer. In another embodiment, the mineral filler includes, but is not limited to, limestone filler, talc, volcanic ash, graphite, carbon black, silica or china clay, quartz, coal fly ash, kaolin, steel slag, and mixtures thereof.

In another aspect, the method of manufacturing comprises a VTAE wherein the VTAE is obtained from a continuous purification process such as a solvent purification process and/or a deep distillation process, or chemical purification. In a further aspect, the VTAE comprises a composition wherein the metals selected from the group consisting of aluminum, barium, boron, cadmium, calcium, chromium, copper, iron, lead, molybdenum, manganese, magnesium, nickel, phosphorous, silver, sodium, tin, titanium, vanadium, and zinc have been reduced to levels below a detectable limit from the standard VTAE.

Accordingly, it is an object of the invention to not encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. §112, first paragraph) or the EPO (Article 83 of the EPC), such that Applicants reserve the right and hereby disclose a disclaimer of any previously described product, process of making the product, or method of using the product.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

These and other embodiments are disclosed or are obvious from and encompassed by, the following Detailed Description.

### BRIEF DESCRIPTION OF THE DRAWINGS

FIG. 1 illustrates a schematic drawing of an overall crude refinery process and where asphalt is produced from crude oil, specifically from vacuum tower bottoms.

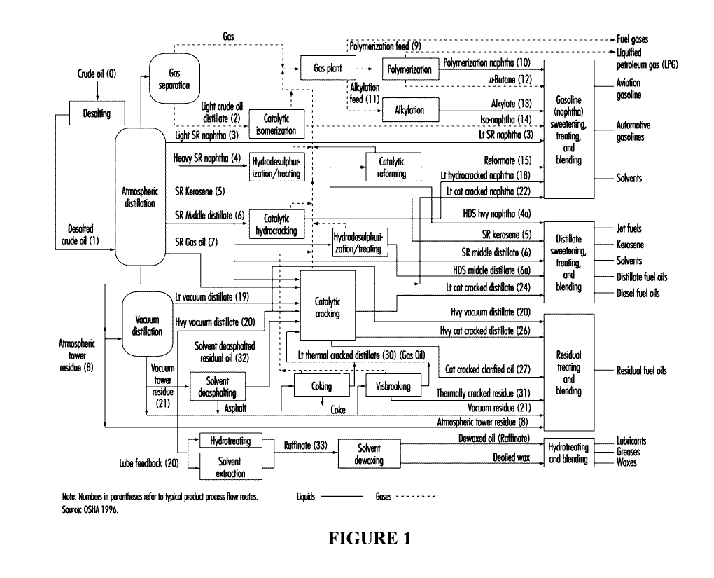

FIG. 2 illustrates a simplified schematic of a crude refinery.

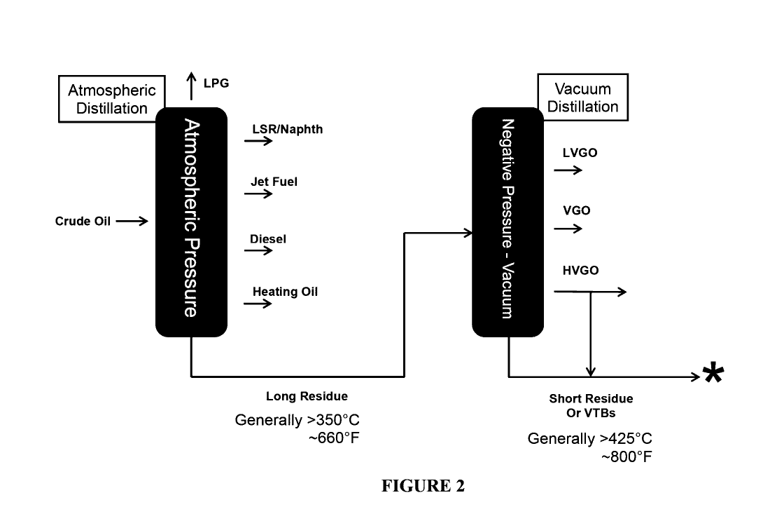

FIG. 3 illustrates asphalt and lube oil production.

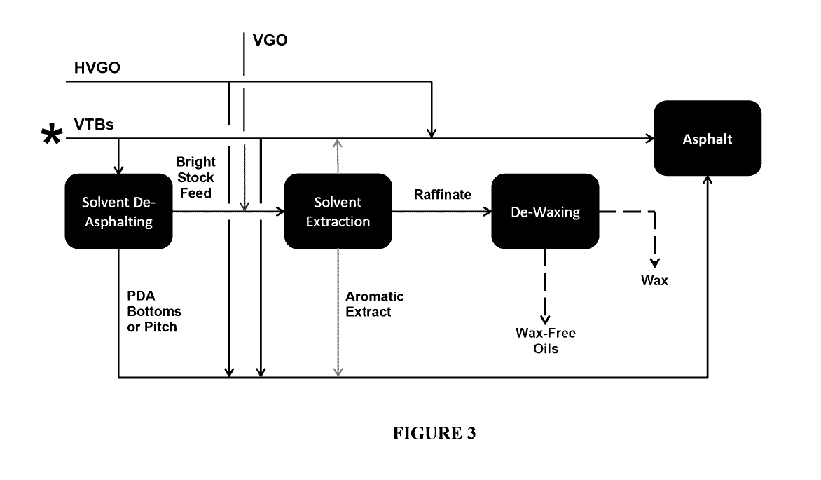

FIG. 4 illustrates the distillation process. (Source: Asphalt Institute/Eurobitume “The Bitumen Industry: A Global Perspective,” Information Series IS-230, 2011).

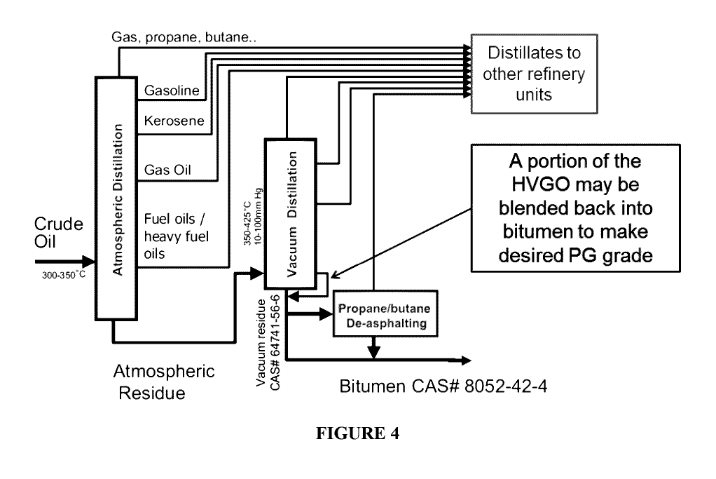

FIG. 5 illustrates lubricating oil production noting that wax-free oils can be further refined.

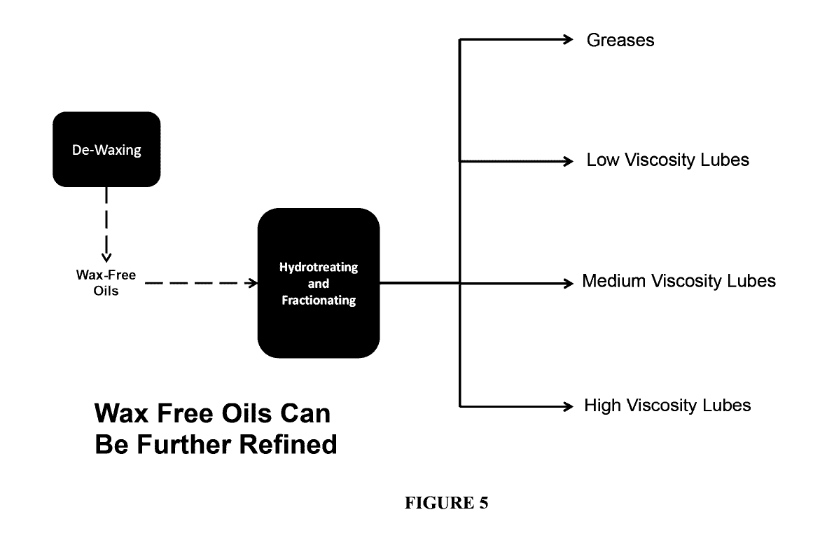

FIG. 6 illustrates VGO production, resulting in “Group I” VTAEs. Typically this process results in a greater abundance of lighter oil in the VTAE.

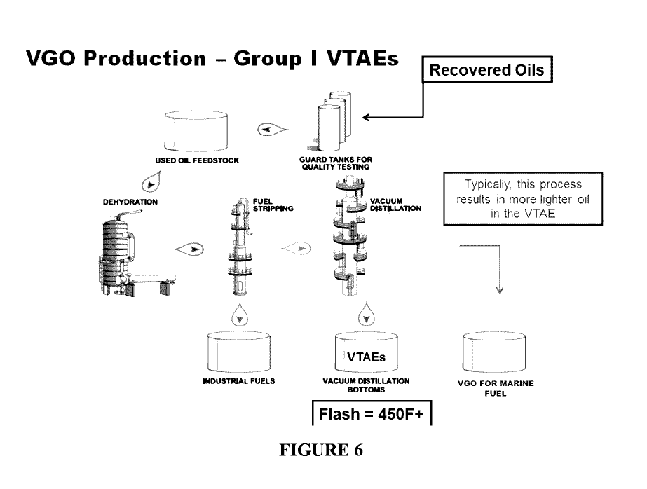

FIG. 7 illustrates Lube Production, resulting in “Group II” VTAEs. Typically this process results in a lower amount of lighter oil in the VTAE.

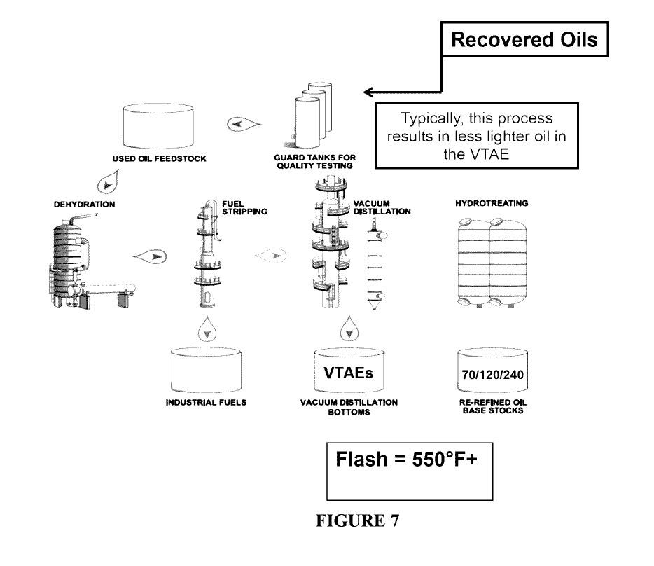

FIG. 8 illustrates the re-refined oils breakdown in a re-refinery for lubes production.

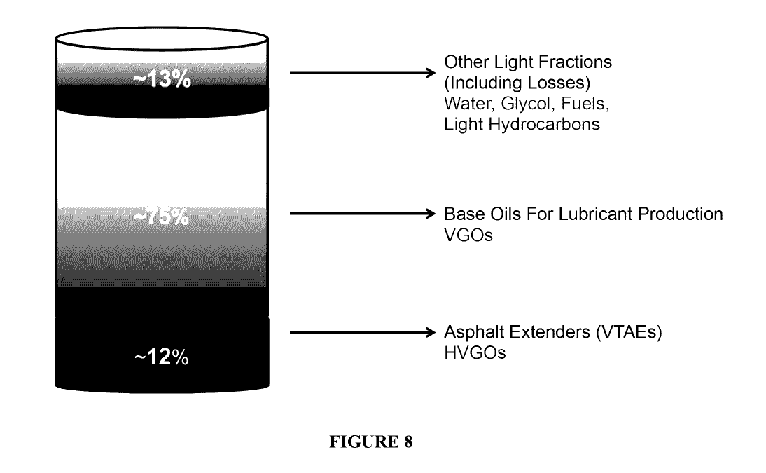

FIGS. 9A and 9B illustrate two photomicrographs of two slides under 100× magnification using standard light transmission microscope a color and texture difference can be seen. (a) purified VTAE after pentane precipitation. (b) standard VTAE as produced through the re-refinery

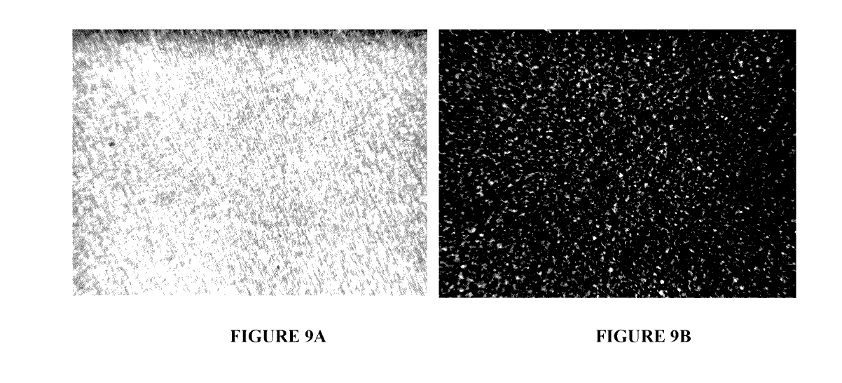

FIG. 10 illustrates mass recovery by distillation cut points.

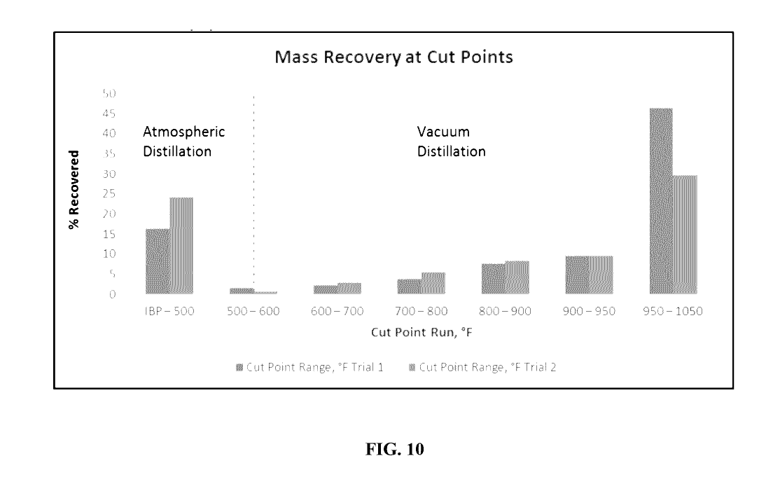

FIG. 11 illustrates the viscosity of the residue at the Atmospheric Equivalent Temperature for 993° F.

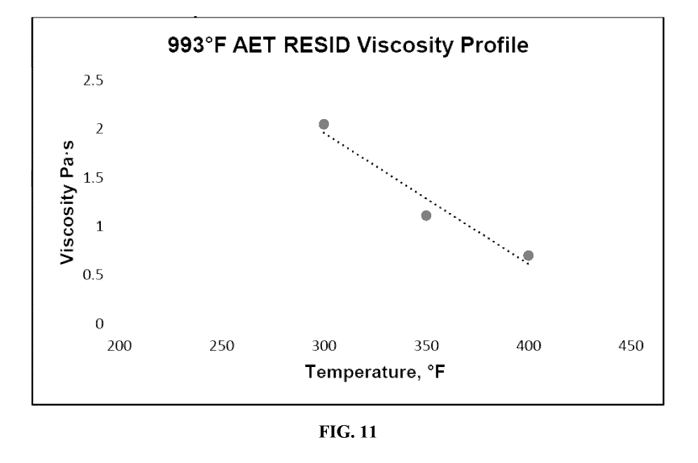

FIG. 12 illustrates illustrate different fractions from the distillation of the vacuum distillation bottoms.

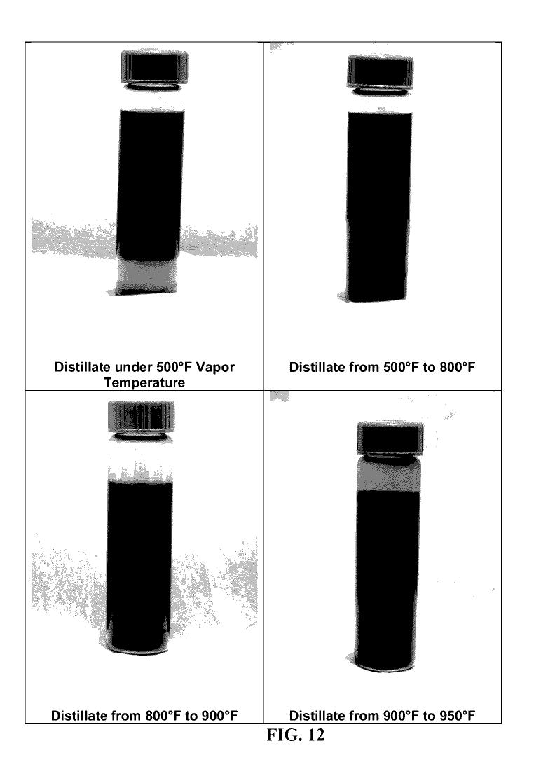

FIGS. 13A and 13B illustrate illustrate different fractions from the distillation of the vacuum distillation bottoms including a fraction which contains the residual material from the distillation process.

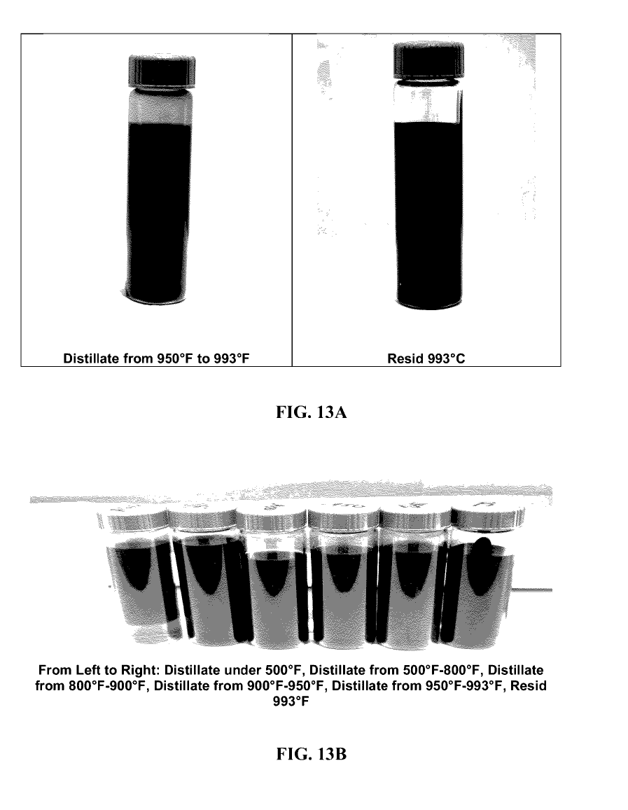

FIG. 14 illustrates the relationship between EcoAddz (VTAE) wt % versus the penetration of the resultant base asphalt.

The following detailed description, given by way of example, but not intended to limit the invention solely to the specific embodiments described, may best be understood in conjunction with the accompanying drawings.

### DETAILED DESCRIPTION OF THE INVENTION

Vacuum Tower Asphalt extender (VTAE) also known as, inter alia, Re-refined Vacuum Tower Bottoms (RVTB), vacuum distillation bottoms (VDB), Re-Refined Engine Oil Bottoms (REOB), are the non-distilled fraction from the re-refining of used engine oils. VTAE have been blended with paving grade binders to improve the low temperature properties for over 20 years.

Conventional methods for the purification of recovered lubricating oils (e.g, Safety-Kleen process) produces a residual material collected in the Vacuum Distillation Bottoms (VDBs) which concentrates the impurities (i.e., metals and particles). These metal and particulate impurities limit the use of VTAE directed towards certain uses as well as certain dosage levels within various applications.

Applicants provide a method of purifying the VTAE involving a separation step and a recovery step. The separation step comprises contacting the VTAE with a hydrocarbon solvent which reduces selective component fractions of standard VTAE, leading to the formation of a filtrate and a mixture of solid materials precipitated from the original VTAE. The resultant prototype filtrates were produced using petroleum-derived solvents of pentane and n-heptane, other solvents would be expected to produce similar results. The solids could be further removed by any conventional means, such as filtration or centrifugation for instance. It is understood that separation of the filtrate and precipitant filter cake may be performed by a variety of industry-accepted processes such as filtration and centrifuging. The purified VTAE is then further recovered from the filtrate by removing the hydrocarbon solvent. The removal of the selected solvent from the filtrate is understood to be by conventional processes to include but are not limited to atmospheric and/or vacuum distillation or similar methodologies. The solvent can then be recycled back into the process. The purified VTAE exhibits an overall reduced solids and metals concentration. The recovered purified VTAE could then be advantageously introduced into a variety of asphalt related applications.

For instance, by combining the purified VTAE with asphalt or bitumen, and processing this combined material using typical conditions of asphalt oxidation (i.e. heating the combined material at 400° F. or more and applying a controlled flow of air through the material), it was discovered that the processing time required to achieve desirable material properties in the oxidized asphalt was reduced significantly. The resulting oxidized product exhibited better performance characteristics after aging compared to asphaltic materials that were aged with standard VTAE or otherwise without the purified VTAE. This improvement is highly desirable for roofing, industrial and paving applications.

In one aspect, the present application provides purified VTAE blended in typical and abundant “paving-grade” asphalts produced a superior flux grade of petroleum asphalt used in the asphalt roofing industry. When the “engineered flux” was air blown, a process whereby air is bubbled through asphalt at elevated temperatures (400° F. or more), the result is asphalt with improved thermal stability. The resultant material is less susceptible to flow or deformation at the typical elevated temperatures incurred during use and is also less susceptible to thermal effects at low temperatures. It is understood that the air blowing process is controllable by altering the temperatures, air rates, air dispersion within the asphalt and diffusion of air through the volume of asphalt (contact time). Typically, the degree of air blowing is measured by increases in the asphalt's complex modulus measured by Softening Point. The asphalt flux is air blown to meet the requirement of the end product use. It is also important to retain the air blown product's low temperature properties, flexibility, to provide utility and usability of the product at cold temperatures.

Not all asphalts can be air blown and retain properties suitable for end use. For example, unmodified paving grade asphalts, when air blown, do not yield properties acceptable for use in steep slope asphalt roofing products.

Applicants discovered that blends of purified VTAE with paving grade asphalts (engineered flux) resulted in air blown products, coatings, which met and/or surpassed the requirements established by the asphalt roofing industry. Improvements identified were reduced air blowing times, improved Softening Point/Penetration relationship at 25° C., improved (increased) flash point, improved cold temperature mandrel bend test temperatures (CTMB), improved accelerated weathering, reduced stain index, improved cold temperature flexibility, while retaining process viscosities similar to standard, non-engineered fluxes.

These improvements also extend to the asphalt paving industry. Air blowing paving grade asphalts are widely used internationally where softer (lower viscosity), more fluid grades are unacceptable for use. In an embodiment, the invention provides a composition blend for use in desert climates where asphalt becomes very soft at high in-service temperatures. Air blowing stiffens the asphalts (increases complex modulus), permitting use in asphalt pavements and related products such as crack and joint sealants.

In another embodiment, the invention provides a stiffer higher modulus binder for use in pavement base courses designed to withstand higher stresses from heavy vehicular traffic such as heavy commercial trucks, planes and trains.

Although the present invention and its advantages have been described in detail, it should be understood that various changes, substitutions and alterations can be made herein without departing from the spirit and scope of the invention as defined in the appended claims.

The present invention will be further illustrated in the following Examples which are given for illustration purposes only and are not intended to limit the invention in any way.

All testing and evaluations were performed by industry accepted protocols published by ASTM, AASHTO, EN, ISO, standards.

It is understood; the improvements discovered have efficacy in a wide assortment of asphalts and asphalt products either individually or collectively. By example, one may select this invention to improve the continuous oxidation processes used world-wide or they may use the invention to produce roofing fluxes from paving asphalts meeting the roofing industries requirements. To illustrate the improved efficiency of purification, Applicants evaluated the recovery of purified VTAE and the resulting levels of wear metals via solvent precipitation followed by filtration assisted with Diatomaceous Earth (DE).

### Examples

Number of Trials: 12

Number of Trials with Accelerated Weathering, (XOM): 12

3 Base Asphalts: Exxon (Ameropan), PG 64-22; BP PG 64-22; Marathon PG 67-22

2 EcoAddz (Brand name for VTAE) (E. Chicago); Standard as produced and ‘De-metaled’ by Pentane Precipitation (Purified VTAE)

TABLE 4
Exxon/Ameropan, PG 64-22 Asphalt, Wt. % (Calumet)

| Blend Designation | E1 | E2 | E3 | E4 |
|---|---|---|---|---|
| Asphalt | 100 | 90 | 80 | 75 |
| VTAE - Std | 0 | 10 | 20 | 25 |
| VTAE - De-metaled | — | — | — | — |

TABLE 5
Marathon, PG 67-22; Wt. % (Garyville)

| Blend Designation | M1 | M2 | M3 | M4 |
|---|---|---|---|---|
| Asphalt | 100 | 90 | 80 | 80 |
| VTAE - Std | 0 | 10 | 20 | — |
| VTAE - Pentane | — | — | — | 20 |

TABLE 6
BP, PG 64-22; Wt. % (Whiting)

| Blend Designation | B1 | B2 | B3 | B4 |
|---|---|---|---|---|
| Asphalt | 100 | 90 | 80 | 80 |
| VTAE - Std | 0 | 10 | 20 | — |
| VTAE - Pentane | — | — | — | 20 |

In Table 6 (Blend B3), roofing flux with preferred target air-blown coating properties of 213-217° F. softening point and 17-19 dmm Penetration 25° C. was investigated. It was found that WEATHER-OMETER® (also referred to as “WOM” throughout the application) failure occurred between 1,500 and 2,000 hours of exposure; 2,000 hours minimum are required for compliance with most shingle manufacturers. It was also found that the addition of 20% standard VTAE improved the key flux and coating properties when compared to the Control (Blend B1), BP's PG 64-22 paving grade asphalt.

This data (Blend B3) showed improved properties: (1) SP/Pen_{25° C.} Relationship—20% VTAE prototype flux exhibited 97° F. SP/188 dmm Pen_{25° C.} vs. the Controls 118° F. SP/68 dmm Pen_{25° C.} (2) The prototype flux blown to coating improved the SP/Pen_{25° C.} Relationship from non-compliant to compliant; (3) Air Blowing Time was improved from 5.3 hrs to 3.9 hrs (≈24% reduction); (4) CTMB Test was improved from 85° F. to 75° F. However, the 75° F. was assessed as high and would be considered non-compliant by most manufacturers; (5) Process viscosities were improved via VTAE use and were assessed as acceptable.

Table 7 illustrates that selected properties evaluated provide base line values for comparison to assess changes due to air blowing, oxidative aging (PAV) and accelerated aging by Xenon arc. The properties selected are a combination of historical empirical properties complemented by selected fundamental properties of materials of PRI's (testing laboratory) discretion. This selection is generic and not specific to any one shingle manufacturer or supplier. The addition of 20% VTAE (Blend B3) reduced the % Asphaltenes and increased % Saturates when compared to the BP Control without VTAE (Blend B1). Other expected changes over the Control were lower Density, lower SP, higher Peneteration_{25° C.}, reduced viscosities at process temperatures, and improved Creep Stiffness values (reduced Stiffness and increased m-Value).

TABLE 8
Flux - Air Blown to Shingle Coating via Laboratory Oxidation

| | | | |
|---|---|---|---|
| Time, | Temp, | SP, ° F. | Pen 77° F., |

| Hrs. | ° F. | Quickie | Regular | dmm |
|---|---|---|---|---|
| 1.0 | 499 | 123.1 | 123 | |
| 1.5 | 497 | 136.3 | 136.5 | |
| 2.0 | 495 | 150.8 | 150.5 | |
| 2.5 | 493 | 166.4 | 166 | |
| 3.0 | 498 | 181.6 | 181 | |
| 3.5 | 496 | 197.2 | 197 | |
| 3.9 | 494 | 209.3 | 210 | |

| | | |
|---|---|---|
| Next Day Results: | 210 | 21 |

Net Charge: 4,000 g
Air Rale: 1.1 L/min

Table 8 illustrates that the flux engineered with VTAE blew down in 3.9 hours, an improvement of 1.4 hours, approximately 26% when compared to the control coating without VTAE. The corresponding Penetration_{25° C.} at 210° F. SP of 21 dmm ‘met’ target requirements and was assessed as within typical industry requirements, 16-25 dmm Penetration_{25° C.} at a 210-225° F. SP.

Softening Point—Penetration 25° C. Relationship: ‘met’ targeted values and was assessed as representative of a typical good performing coating for use in shingles.

Flash Point: increased the Flux from 580° F. to 640° F., typical for oxidized flux materials. The increase results from the combination of polymerization and light end volatile losses. The increase to 640° F. was also above the Controls 625° F. FP, which is attributed to the presence of VTAE.

Component Fractions: changes in fractions due to air blowing and compared to the Control coating were assessed as improved with a higher % Saturates.

Stain Index: The SI value of 6.8 falls in the Low Staining Tendency Range noted in ASTM D 2746. (Note: ASTM D 2746 Staining Tendency Index Ranges 0-10=Low; 10-20=Moderate; ≧20=High)

Granule Adhesion: The protocol entails construction of shingle like specimens using similar architecture to conventional shingles w.r.t. coating thickness except the coating is unfilled, granule surfacing and embodiment followed by a ‘Granule Adhesion evaluated by ASTM D 4977 to quantify granule adhesion. This provides an indication the prototype air blown coating possesses acceptable granule adhesive properties.

DSR Frequency Sweep: a property measured by some shingle manufacturers to provide insight on the coatings response to strain rates and subsequently resist cracking and movement of the shingle when applied due to thermal expansion and contraction and/or thermal shock (e.g., rain).

The values for this coating from an engineered flux were similar to in use coatings.

Low Temperature Flexibility/Cold Temperature Mandrel Bend Test: a subjective and empirical testing protocol included in nearly all shingle manufacturers' coating specifications. The results provide insight on handling properties of shingles during various application temperature conditions. Typically coatings crack at temperatures in the 50-60° F. range, which is generally assessed as acceptable, requirements differ by manufacturer.

The results, 75° F., for this prototype coating were assessed as poor/non-compliant with most manufacturer requirements. However, presence of VTAE improved CTMB when compared to Control without VTAE with 85° F. (Note: a gain (lower temperature) in 5° F. is considered significant.)

Viscosity Profile—Unfilled: standard rotational viscosity protocols used to primarily address the ease and ability to process the coating into shingles.

This coating exhibited slightly lower viscosities (slightly preferred) over the relevant process temperature range for shingle production albeit without filler. These viscosities would be expected to extend into viscosities for the filled coating and thereby facilitate processing at the coater.

Filled Coating Properties: evaluations were outside the scope of this efficacy study. Assessments of filled coating properties are typically done with identified fillers for the specific manufacturing plant. Filler types vary greatly and the manufacturing plants tend to use locally available mineral fillers to minimize logistics and costs.

Softening Point—Penetration: ratio changes indicated a susceptibility to oxidative aging. Rotational viscosities confirmed the aging sensitivity, exhibiting 7×+ increase.

CTMB Test: temperatures increased, as expected, to 90° and 95° F. for the two (2) PAV times. The increase was assessed as excessive.

WEATHER-OMETER® failure occurred between 1,500 and 2,000 hours of exposure. At 2,000 hours, pinholes/cracks recorded in 15.8% of the grids with an accompanying mass loss of 7.7%.

Results: Oxidations with VTAE after Pentane Precipitation: 80% Base Asphalt+20% VTAE-Pentane (Purified VTAE—Blend B4) compared to 80% Base+20% Std. VTAE (Blend B3). Property Improvements Exhibited by ExcoAddz-Pentane: (1) Reduced Oxidation Time (≈30% less) (2) Improved/Increased Penetrations_{25° C.} (3) Improved Stiffness (lower ≈25%) and m Values (higher ≈7%)_{-30° C.} (4) Improves (≈10° F.) Cold Temperature Mandrel Bend Test Values). Other Results: Dosages for standard VTAE @ 25% with Exxon PG 64-22 Failed Accelerated Weathering (XOM) Criteria and Dosage of 20% Standard VTAE yielded borderline XOM results, results would be compliant with some manufactures but not all.

Applicant compared 80% Base Asphalt+20% VTAE-Pentane (Purified VTAE—Blend B4) to 80% Base+20% Std. VTAE (Blend B3). Applicant found that purified VTAE demonstrated higher improved properties which increases application towards wider applications than conventional uses.

Table 12 illustrates a comparison of selected properties between the BP base asphalt, pentane modified VTAE, and the resultant 80% base Asphalt+20% VTAE-Pentane (Purified VTAE—Blend B4). The pentane modified VTAE exhibited zero (0) asphaltenes in addition to zero (0) naphthene aromatics and a lower absolute viscosity_{60° C.}. The prototype blend (Blend B4) exhibited a 105° F. softening point/242 dmm penetration_{25° C.} with a flash point of 611° F. (322° C.) and a creep stiffness at −30° C. of 143 MPa with a 0.366 m-value. These results are in comparison to 80% BP base asphalt+20% Standard VTAE with a 97.3° F. softening point/188 dmm penetration_{25° C.} with a 580° F. (304° C.) flash point and a creep stiffness of 187 MPa with a 0.340 m-value.

These results demonstrated that prototype BP Flux (80/20) using Pentane Eco Addz when compared to the prototype BP flux using standard Eco Addz provided higher softening point (105° F. vs. 97° F.), higher penetration_{25° C.} (242 vs. 188 dmm), higher flash point (611° F. vs. 580° F.), lower absolute viscosity (534 P vs. 650 P), and improved creep stiffness_{-30° C.} (lower stiffness: 143 vs. 187 MPa and higher m-value: 0.366 vs. 0.340).

TABLE 13
Prototype Flux - Air blown to Shingle
Coating via Laboratory Oxidation

| | | | |
|---|---|---|---|
| Time, | Temp, | SP, ° F. | Pen 77° F., |

| Hrs. | ° F. | Quickie | Regular | dmm |
|---|---|---|---|---|
| 1.0 | 498 | 130.4 | 130.5 | |
| 1.5 | 495 | 155.7 | 156 | |
| 2.0 | 493 | 178.9 | 179 | |
| 2.5 | 498 | 193.1 | 193 | |
| 3.0 | 496 | 210.8 | 210 | |

| | | |
|---|---|---|
| Next Day Results: | 210 | 19 |

Net Charge: 2,400 g
Air Rate: 1.2 L/min

After a period of three hours where the prototype flux was air blown, an improvement of 23% (3.0 hrs vs. 3.9 hrs) was observed compared to the BP prototype flux with 20% Standard VTAE. The corresponding penetration_{25° C.} at 210° F. softening point “met” target requirements and was assessed as excellent compared to typical industry requirements (i.e., 16-25 dmm penetration_{25° C.} at a 210-225° F. softening point.)

Table 14 illustrates a comparison of 80% BP with 20% Pentane VTAE vs. Standard VTAE. With regard to the softening point—penetration_{25° C.} relationship (“SP/Pen”), both prototypes exhibited preferred SP/Pen values: 210 F/19 dmm for Pentane VTAE vs. 210 F/21 dmm for Standard VTAE. The Pentane Prototype flash point exhibited a 20° F. increase compared to the Standard VTAE (660° F. vs. 640° F.). Both were above the BP control with a 625° F. flash point. The Pentane VTAE also exhibited lower % Asphaltenes and higher % saturates with a Colloidal Instability Index (“CI”) of 0.709 vs. 0.764 where the lower CI is preferred.

With regard to the stain index (SI), an SI value of 4 for the Pentane VTAE falls within the “low staining tendency range” according to ASTM D 2746.

DSR Frequency Sweep: According to Table 11, the values for this coating from an engineered flux were both similar to “in-use” coatings.

Low Temperature Flexibility/Cold Temperature Mandrel Bend Test: Pentane VTAE exhibited a significant improvement in CTMB temperatures, with a 50° F. vs. 75° F. for Standard VTAE. Both exhibited improvement over the Control 85° F., coating without VTAE. (Note: a gain (lower temperature) in 5° F. is considered significant.)

Viscosity Profile—Unfilled: The Pentane VTAE prototype exhibited slightly higher viscosities when compared to the Standard VTAE coating. However, both were lower than the control coating without VTAE; lower viscosities are preferred.

The results demonstrate that the PAV properties suggest a higher degree of oxidative aging when compares to the standard 20% VTAE addition. The softening points were higher (260° F. vs. 250° F. for PAV₂₀ and 270° F. vs. 252 for PAV₄₀ₕᵣ). However, the penetration values were higher, thus exhibiting an improvement (13 vs. 9 for PAV₂₀ and 11 vs 8 for PAV₄₀ₕᵣ) possibly indicating an association to differences in SARA fractions. The Pentane VTAE resulted in lower Asphaltenes and higher Saturates (Asphaltenes were lower by approximately 3% and Saturates were higher by approximately 3%. Applicant found that rotational viscosities exhibited a significant increase when compared to standard VTAE. Additionally CTMB test temperatures were 5 F lower than those determined with 20% standard VTAE, which is consistent with the Pentration and SARA fraction results.

Table 16 illustrates failure per ASTM D 1670 criteria occurred at 2,500 hours with approximately 12% pinholes/cracking. The Mass Loss (not a D 1670 criterion) was lower than typical at failure (2.500 hours). The asphalt blend containing standard VTAE (Blend B3) failed between 1,500 and 2,000 hours, representing a significant improvement when using purified VTAE.

% Ash Removal by Pentane & n-Heptane Precipitation in Production of Purified VTAE

VTAE Ash_{12 Samples} %: Avg.=8.775; SD=0.89

VTAE Filtrate After Pentane Ppt.: Ash %=4.02; % Ash Reduction=54.2

VTAE Filtrate After n-Heptane Ppt: Ash=4.40; % Ash Reduction=49.9

Ash % Determined by ASTM E1131, TGA (Note: % Ash via TGA vs. ASTM D 482 difference approximately ±0.2%)

### Method of Purifying VTAE

The method of purifying the VTAE involves a separation step and a recovery step. The separation step comprises contacting the VTAE with a hydrocarbon solvent which reduced selective component fractions of standard VTAE, leading to the formation of a filtrate and a mixture of solid materials precipitated from the original VTAE. The resultant prototype filtrates were produced using petroleum-derived solvents of pentane and n-heptane, other solvents would be expected to produce similar results. The solids could be further removed by any conventional means, such as filtration or centrifugation for instance. It is understood that separation of the filtrate and precipitant filter cake may be performed by a variety of industry-accepted processes such as filtration and centrifuging. The purified VTAE is then further recovered from the filtrate by removing the hydrocarbon solvent. The removal of the selected solvent from the filtrate is understood to be by conventional processes to include but not be limited to atmospheric and/or vacuum distillation or similar methodologies. The solvent can then be recycled back into the process. The purified VTAE exhibits an overall reduced solids and metals concentration. The recovered purified VTAE could then be advantageously introduced into a variety of asphalt

### RELATED APPLICATIONS

The purified VTAE was combined with asphalt or bitumen in a 80/20 ratio (80% asphalt, 20% purified VTAE; Blends M4, B4) and processing this combined material using typical conditions of asphalt oxidation (i.e. heating the combined material at 400° F.+ and applying a controlled flow of air through the material). The 80/20 blends were used to compare the material properties of purified VTAE to the same blend ratio using standard VTAE. Material property improvements were noted when using purified VTAE as described above. It is expected that improvements would be seen using purified VTAE at various concentrations when compared to control asphalts as well as the same blend ratios using standard VTAE.

### Distillation

Applicants provide a method of purifying VTAE to further reduce the wear metal content by employing an atmospheric and/or vacuum distillation to afford, essentially, a heavy vacuum gas oil (HVGO). The distillation extracts a portion of the vacuum tower column which is essentially free of metals and ash; therefore, the residual material recovered from the distillation contains a high concentration of metals and ash which is discarded or used in other applications. The residue might be further used in a variety of processes which may include, but are not limited to, blending with other asphalt/bitumen materials for use in cutback asphalt applications, as a binder for pavement preservation techniques such as full depth reclamation and cold in-place recycling, water and damp proofing applications, oxidation catalysts, cross-linking agent for polymer modified asphalts, among others.

In a related aspect, Applicants provide a method of further purifying VTAE to further reduce the wear metal content by employing an atmospheric and/or vacuum distillation subsequent to purified VTAE achieved through solvent precipitation. The resulting distilled product affords, essentially, a heavy vacuum gas oil (HVGO). The distillation extracts a portion of the vacuum tower column which is essentially free of metals and ash; therefore, the residual material recovered from the distillation contains a high concentration of metals and ash which is discarded or used in other applications.

In an aspect of the invention, distillation of the VTAE has an initial boiling point of 725° F. to 800° F. with a final boiling point in the range of 1600° F. to 1700° F.

A summary of wear metal content by each distillation cut is illustrated in Table 17:

| | | Results, by Cut Point Range, ° F. | | | | |
|---|---|---|---|---|---|---|
| | Test | | IBP- | 500- | 900- | |
| Property | Method | Newark | 500 ¹ | 900 ² | 948 | 948+ |

Metals by ICP

| | | | | | | | |
|---|---|---|---|---|---|---|---|
| Metal, | Ag | D5185 | | BDL | BDL | BDL | BDL |
| ppm | Al | IP 501 | 1 | 4.8 | 3.3 | 3.5 | 559 |
| | B | | | BDL | BDL | BDL | 35,073 |
| | Ba | | | BDL | BDL | BDL | BDL |
| | Ca | | 10 | BDL | BDL | BDL | 35,074 |
| | Cd | | | BDL | BDL | BDL | BDL |
| | Cr | | | BDL | BDL | BDL | BDL |
| | Cu | | | BDL | BDL | BDL | 257 |
| | Fe | | ≦1 | 18.5 | BDL | BDL | 2,678 |
| | Mg | | | BDL | BDL | BDL | 2,013 |
| | Mn | | | BDL | BDL | BDL | BDL |
| | Mo | | | BDL | BDL | BDL | 845 |
| | Na | | 12 | BDL | BDL | BDL | 8,440 |
| | Ni | | ≦1 | BDL | BDL | BDL | BDL |
| | P | | 5 | BDL | BDL | BDL | 10,267 |
| | Pb | | | BDL | BDL | BDL | BDL |
| | Si | | ≦10 | 53.2³ | 23.3³ | 3.8³ | 417 |
| | Sn | | | BDL | BDL | BDL | BDL |
| | Ti | | | BDL | BDL | BDL | BDL |
| | V | | ≦1 | BDL | BDL | BDL | BDL |
| | Zn | | 4 | BDL | BDL | BDL | 11,496 |

¹ Atmospheric Distillation Distillate Cut (IBP-760° F.)
² Combined Cuts: 500-600; 600-700; 700-800, & 800-900
³Origin unknown, requires investigation

Table 18 illustrates a summary of “key” wear metal concentrations from original distillation trial:

| | Concentration, ppm | | |
|---|---|---|---|
| | | Distillation Resid | Concentration |
| Wear Metal | VTAE as Rec'd | (>993° F. AET) | Ratios |
| Phosphorous | 4,963 | 14,668 | 2.96 |
| Zinc | 5,093 | 12,834 | 2.52 |
| Calcium | 12,709 | 36,284 | 2.85 |
| Molybdenum | 318 | 829 | 2.61 |
| Iron | 1,054 | 2,969 | 2.82 |
| Total | 24,137 | 67,584 | 2.80 |

Table 17 demonstrates that almost every metal analyzed was reduced by nearly 100% and Table 2 demonstrates that the mass balance confirms that the residue from the distillation contains the missing metals from the distillation cuts.

Table 19 illustrates a summary of distillation mass balances:

| | | | | | |
|---|---|---|---|---|---|
| | Charge, g | Weight, | Volume, | Mass, | Volume, |
| Cut Range | (ml) | g | ml | % | % |

Atmospheric Distillation

| | | | | | |
|---|---|---|---|---|---|
| IBP-260° C. | 6804.3 | 1651.7 | 2109.5 | 24.3 | 49.5 |
| (IBP-500° F.) | | | | | |
| 260° C.+ | — | 3935.5 | — | 57.8 | — |
| (500° F.+) | | | | | |
| Loss | — | 1217.1 | — | 17.9 | — |

Vacuum Distillation

| | | | | | |
|---|---|---|---|---|---|
| 260° C.-316° C. | — | 55.8 | 67.6 | 0.8 | 1.6 |
| (500° F.-600° F.) | | | | | |
| 316° C.-371° C. | — | 210.3 | 246.8 | 3.1 | 5.8 |
| (600° F.-700° F.) | | | | | |
| 371° C.-427° C. | — | 377.6 | 437.6 | 5.6 | 10.3 |
| (700° F.-800° F.) | | | | | |
| 427° C.-482° C. | — | 569.5 | 652.4 | 8.4 | 15.3 |
| (800° F.-900° F.) | | | | | |
| 482° C.-510° C. | — | 653.9 | 745.6 | 9.6 | 17.5 |
| (900° F.-950° F.) | | | | | |
| 510° C.-534° C. | — | 2027.9 | — | 29.7 | — |
| (950° F.-993° F.) | | | | | |
| 534° C.+ | — | 1262.6 | — | 18.6 | — |
| (993° F.+) | | | | | |
| Loss | — | 5158.6 | — | 75.8 | NC |

The data provided herein demonstrates that the distillation process provides a marked improvement over currently known methods. The distillation process provides a number of options for value-added products, in and outside the asphalt industry such as marine fuels, process oils, compatibility for polymer modified asphalts, paving binders and mixes, roofing fluxes and resultant air-blown coatings, and performance enhanced asphalt extender.

The purification of VTAE using the distillation process pertaining to this application showed better results in the removal of metals and other solids and therefore, there may be equal to, or better, material properties achieved in oxidized asphalt blends as described above.

Not all asphalts can be air blown and retain properties suitable for end use. For example, unmodified paving grade asphalts, when air blown, do not yield properties acceptable for use in steep slope asphalt roofing products. However, it was shown that solvent purified VTAE blended with paving grade asphalt, and then oxidized, showed that the blended product could be used in such applications as industry specifications could be met. The purification of VTAE using the distillation process pertaining to this application showed better results in the removal of metals and other solids and thus, we would anticipate similar or better material properties when using the distillation purified VTAE in oxidized asphalt blends as described above.

Applicants discovered that blends of purified VTAE, using the solvent purification process, with paving grade asphalts (engineered flux) resulted in air blown products, coatings, which met and/or surpassed the requirements established by the asphalt roofing industry. Improvements identified were reduced air blowing times, improved Softening Point/Penetration relationship at 25° C., improved (increased) flash point, improved cold temperature mandrel bend test temperatures (CTMB), improved accelerated weathering, reduced stain index, improved cold temperature flexibility, while retaining process viscosities similar to standard, non-engineered fluxes. The purification of VTAE using the distillation process pertaining to this application showed better results in the removal of metals and other solids and therefore, there may be equal to, or better, material properties achieved in oxidized asphalt blends as described above.

In the roofing industry, these improvements would exhibit efficacy in both the steep and low slope roofing sectors, typical product types are: built-up roofing mopping asphalt, ply and cap sheets, shingles, rolled roofing products, and components of shingles such as tab sealants and laminating adhesives.

These improvements also extend to the asphalt paving industry. Air blowing paving grade asphalts are widely used internationally where softer (lower viscosity), more fluid grades are unacceptable for use. In an embodiment, the invention provides a composition blend for use in desert, or other high temperature, climates where asphalt becomes very soft at high in-service temperatures. Air blowing stiffens the asphalts (increases complex modulus), permitting use in asphalt pavements and related products such as crack and joint sealants.

In another embodiment, the invention provides a stiffer higher modulus binder for use in pavement base courses designed to withstand higher stresses from heavy vehicular traffic such as heavy commercial trucks, planes and trains.

It is understood, the improvements discovered have efficacy in a wide assortment of asphalts and asphalt products either individually or collectively. By example, one may select this invention to improve the continuous oxidation processes used world-wide or they may use the invention to produce roofing fluxes from paving asphalts meeting the roofing industries requirements.

It is also understood that the present disclosure relates to utilizing the heavy vacuum gas oil in a variety of applications such providing a fuel oil blend for the operation of a combustion engine or gas turbine. In this aspect, the HVGO permits the engine to operate at a higher efficiency and/or, in general, to combust more efficiently. Better combustion efficiencies may result in fewer pollutants and/or exhaust byproducts, as well as reduced fuel consumption.

### Examples

The 500°−600° F., 600°−700° F., 700°−800° F., 800°−900° F. were proportionately combined to yield a 500°−900° F. composite. The results illustrated in Table 21 suggests the 500°−900° F. composite modified would function as a compliant blend component meeting Chevron (Marine Fuel) Guidelines if some minor modifications to the process were to be made.

The results illustrated in Table 22 suggests that the 900°−948° F. distillation cut would also function as a compliant blend component meeting Chevron (Marine Fuel) Guidelines.

TABLE 23
Distillation Data

| | | | |
|---|---|---|---|
| | Temperature | Recovered, | % of |
| Distillation Cut | Range, ° F. | g | Charge |

Atmospheric Distillation: EcoAddz Charge = 6,804.3 g

| | | | |
|---|---|---|---|
| 1 | ~70-500 | 2,868.8^{2.} | 42.2 |
| 2 | 500-760^{1.} | 3,935.5^{2.} | 57.8 |

Vacuum Distillation^{3.} = Charge = 3,935.5 g
(operating vacuum 0.64 mmHg

| | | | |
|---|---|---|---|
| 3 | 500-600 | 55.8 | 0.8 |
| 4 | 600-700 | 210.3 | 3.1 |
| 5 | 700-800 | 377.6 | 5.5 |
| 6 | 800-900 | 269.5 | 8.4 |
| 7 | 900-948^{3.} | 653.9 | 9.6 |
| Resid | 948+^{4.} | 2,022.9 | 29.7 |
| Loss | | 18.6 | 0.3 |

^{1.}Modified Pot Temp to 760° F. with resistant Vapor Temperatures = 500° F.,
^{2.}Nomalized value, recovery traps were leaking.
^{3.}Cracking observed (loss of vacuum).
^{4.}Resid was partially solid and partially liquid

TABLE 25
Simulated Distillation of Newark Vacuum Gas Oil
versus VTAE Distillation Cuts and Residues:

| | | Results, by Cut Point Range, ° F. | | | | |
|---|---|---|---|---|---|---|
| | Test | New- | IBP- | 500- | 900- | |
| Property | Method | ark ² | 500 ¹ | 900 ³ | 948 | 948+ |

Simulated Distillation

| Initial | | D 2887/ | 537.58 | 184.84 | 539.36 | 544.59 | N/A |
|---|---|---|---|---|---|---|---|
| Boiling | | 6352 | | | | | |
| Point, | | | | | | | |
| IBP, ° C. | | | | | | | |
| Temper- | 5 | | 666.12 | 212.72 | 714.19 | 734.75 | N/A |
| ature | 10 | | 706.16 | 241.68 | 758.87 | 790.59 | N/A |
| ° F., at | 15 | | 727.24 | 264.40 | 779.72 | 821.85 | N/A |
| Percent | 20 | | 742.78 | 295.48 | 799.52 | 839.58 | N/A |
| Off: | 25 | | 755.40 | 323.78 | 813.40 | 866.44 | N/A |
| | 30 | | 766.44 | 344.30 | 822.94 | 879.63 | N/A |
| | 35 | | 776.47 | 365.27 | 831.77 | 889.07 | N/A |
| | 40 | | 785.82 | 386.52 | 840.19 | 897.54 | N/A |
| | 45 | | 794.81 | 409.52 | 856.59 | 912.65 | N/A |
| | 50 | | 803.91 | 430.67 | 871.67 | 926.15 | N/A |
| | 55 | | 813.59 | 450.33 | 879.53 | 933.86 | N/A |
| | 60 | | 823.62 | 471.18 | 887.69 | 942.31 | N/A |
| | 65 | | 834.40 | 488.44 | 896.29 | 954.01 | N/A |
| | 70 | | 846.16 | 510.46 | 912.53 | 972.40 | N/A |
| | 75 | | 858.83 | 531.47 | 929.01 | 985.58 | N/A |
| | 80 | | 873.41 | 552.98 | 941.99 | 1010.70 | N/A |
| | 85 | | 889.16 | 575.59 | 969.99 | 1046.10 | N/A |
| | 90 | | 908.64 | 599.76 | 1014.00 | 1112.10 | N/A |
| | 95 | | 936.09 | 645.08 | 1110.50 | 1185.50 | N/A |

| | | | | | |
|---|---|---|---|---|---|
| Final Boiling | 1,006.90 | 773.19 | 1284.20 | 1328.90 | N/A |
| P, ° F. | | | | | |

¹ Atmospheric Distillation Distillate Cut (IBP-760° F.)
² Newark VGO Reported by AmSpec; T1 + T2 Stream, Sample Date Jul. 9, 2015
³ Combined Cuts: 500-600; 600-700: 700-800 & 800-900

Table 26 summarizes the amount of wear metals found in the Newark VGO and VTAE distillation cuts and residue:

| | | Results, by Cut Point Range, ° F. | | | | |
|---|---|---|---|---|---|---|
| | Test | | IBP- | 500- | 900- | |
| Property | Method | Newark² | 500¹ | 900³ | 948 | 948+ |

Metals by ICP

| | | | | | | | |
|---|---|---|---|---|---|---|---|
| Metal, | Ag | D5185 | | BDL | BDL | BDL | BDL |
| ppm | Al | IP 501 | 1 | 4.8 | 3.3 | 3.5 | 559 |
| | B | | | BDL | BDL | BDL | 35,073 |
| | Ba | | | BDL | BDL | BDL | BDL |
| | Ca | | 10 | BDL | BDL | BDL | 35,074 |
| | Cd | | | BDL | BDL | BDL | BDL |
| | Cr | | | BDL | BDL | BDL | BDL |
| | Cu | | | BDL | BDL | BDL | 257 |
| | Fe | | ≦1 | 18.5 | BDL | BDL | 2,678 |
| | Mg | | | BDL | BDL | BDL | 2,013 |
| | Mn | | | BDL | BDL | BDL | BDL |
| | Mo | | | BDL | BDL | BDL | 845 |
| | Na | | 12 | BDL | BDL | BDL | 8,440 |
| | Ni | | ≦1 | BDL | BDL | BDL | BDL |
| | P | | 5 | BDL | BDL | BDL | 10,267 |
| | Pb | | | BDL | BDL | BDL | BDL |
| | Si | | ≦10 | 53.2^{4.} | 23.3^{4.} | 3.8^{4.} | 417 |
| | Sn | | | BDL | BDL | BDL | BDL |
| | Ti | | | BDL | BDL | BDL | BDL |
| | V | | ≦1 | BDL | BDL | BDL | BDL |
| | Zn | | 4 | BDL | BDL | BDL | 11,496 |

It is expected that improvements would be seen using purified VTAE at various concentrations when compared to control asphalts as well as the same blend ratios using standard VTAE. It is believed that the material properties improvements are directly related to the reduction in the metals content and other impurities in the VTAE. Thus, it is expected that the VTAE distillation-derived HVGO would impart similar or improved materials property improvements compared to similar blend ratios using standard VTAE as well as purified VTAEs using the solvent purification process.

### Peel-n-Stick

It is understood, the improvements discovered have efficacy in a wide assortment of asphalts and asphalt products either individually or collectively. By example, one may select this invention to produce roofing fluxes from paving asphalts meeting the roofing industries requirements. To illustrate the improved and unexpected properties of the roofing composition, Applicants have evaluated the performance of VTAE as an extender in “peel-n-stick” compounds and compositions. In sum, the use of VTAE as an extender demonstrated an affinity for polymers typically used in peel-n-stick formulations such as poly(styrene-butadiene-styrene) (“SBS”) and tackifying resins, facilitating the mixing and blending processes. Therefore the use of VTAE permits the use of less polymers without sacrificing performance requirements. Excluding the sheet materials, polymers are the most cost-laden material.

Two manufacturing process methods were developed using VTAE in the manufacture of “peel-n-stick” products. The first option entails directly modifying a “harder” base asphalt to produce a “softer” base asphalt generally exhibiting properties of a typical asphalt flux, creating an admixture step. Softer asphalts which generally entail 200-300, 300-400 Pen graded or PG 46-XX, 52-XX or 58-XX, or AC-5 are typically difficult to locate and cost more. A softer base asphalt is required to produce a satisfactory adhesive. The use of VTAE (EcoAddz) permits the manufacturer to purchase local asphalt, which is more efficient logistically and cost-wise, and blend with the VTAE by conventional means to produce a technically viable base asphalt used in subsequent peel-n-stick compound formulations.

Table 27 illustrates two trials where the comparative formulation shows improved key properties. The softening point change from 210.5 to 245.0, increased elongation at break percentage from 95 to 97.5, and significant increase of adhesion to plywood at 40° F. is indicative of increased polymer dissolution primarily based on the order of addition and not on the amount of addition of VTAE. Both sets of values for increased adhesion to plywood at elevated temperatures are higher than typical articles of commerce due to formula selected

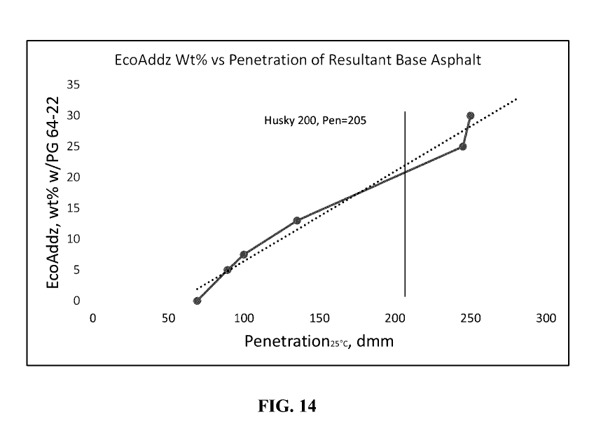

Data from Table 28 as well as FIG. 14 illustrates the proportionate use of VTAE which allows the user to “match” key properties of a “softer” asphalt. In a selected blend, 78.5% base asphalt (PG 64-22, Pen_{25° C.}=69 dmm)+21.5% VTAE (EcoAddz), the resultant composition exhibited a favorable restructuring in component fractions. Asphaltenes were reduced by 11% (from 12.0 to 10.7) and Saturates were increased 38% (from 10.5 to 14.5%). These properties indicate a better balanced asphalt with improved durability/performance.

The second option entails using VTAE (EcoAddz) directly in peel-n-stick compound formulations, thus foregoing the admixture step. The present application provides a direct batch addition method comprising (1) base asphalt (2) VTAE (3) SBS polymer (4) tackifying resin (5) limestone filler. Applicants discovered that the order of addition improved the efficiency of polymer dissolution, where the VTAE increased the solubility of polymer which allows the manufacturer to use less polymer to achieve the desired properties. Comparative trials confirmed a formulation comprising direct batch addition at approximately 25% addition of VTAE.

TABLE 27
Investigation of Peel-n-Stick Composition

| | | | | Typical |
|---|---|---|---|---|
| | | Pre-Blend | | Commercial |
| | | Asphalt and | Direct Batch | Self Adhering |
| | | VTAE | Addition | Membrane |
| Source of VTAE % | | | | |
| Base Asphalt | | 10.6 | — | — |
| Direct Batch Addition | | 15.0 | 25.0 | — |
| Total | | 25.6 | 25.0 | — |
| Key Properties | | | | |
| Softening Point | | 210.5 | 245.0 | — |
| Penetration_{25° C.} | | 89 | 87 | — |
| Elongation at Break, % | | 95 | 97.5 | 70-80 |
| Adhesion | @40° F. | 57.4 | 98.0 | 2-5 |
| to Plywood, | @75° F. | 32.0 | 31.6 | 12-50 |
| lb/ft width | | | | |

Table 30 provides a comparison of different processes. The data specifically illustrates the improved results (shown in underlined format) where direct blend processes is preferred with an increase in adhesion to plywood.

Table 31 illustrates and provides additional examples of the different processes e.g., direct addition at two different dosages of VTAE and pre-blend.

Tables 29 through 31 illustrate the various compositions and addition of the VTAE as an Extender to be used in construction materials. The tables provide a comparison of a control formula with the petroleum extract (e.g, data labelled “03”) and other formulations without the petroleum extract, but with the VTAE at different dosages and various processes of addition. The data confirms that one is able substitute the petroleum extract with VTAE and achieve the same and/or superior performance of self-adhering polymer modified bituminous sheets with high adhesion to plywood elongation at break while still passing all standard criteria in the industry.

Having thus described in detail preferred embodiments of the present invention, it is to be understood that the invention defined by the above paragraphs is not to be limited to particular details set forth in the above description as many apparent variations thereof are possible without departing from the spirit or scope of the present invention.

What is claimed is:

1. A continuous process of purifying Vacuum Tower Asphalt Extender (VTAE) comprising:
(a) contacting the VTAE with a hydrocarbon solvent or a hydrocarbon solvent mixture thereof;
(b) precipitating a mixture of solid materials with the solvent or solvent mixture;
(c) filtering the mixture of solid materials and filtrate;
(d) concentrating the filtrate whereby the purified VTAE is obtained;
wherein the hydrocarbon solvent or hydrocarbon solvent mixture thereof is able to be recycled back into contacting the VTAE with a hydrocarbon solvent or a hydrocarbon solvent mixture thereof.

2. The continuous process according to claim 1, wherein the hydrocarbon solvent is at least one petroleum-derived hydrocarbon solvent.

3. The continuous process according to claim 1, wherein the hydrocarbon solvent mixture is at least two solvents selected from the group consisting of pentane, hexane, n-pentane, n-heptane.

4. The continuous process according to claim 1, wherein the hydrocarbon solvent is selected from the group consisting of pentane, hexane, n-pentane, n-heptane.

5. A continuous process of combining purified VTAE according to claim 4 with asphalt or bitumen comprising applying a controlled flow of air through the material at a temperature range from 300° F. to 600° F.

6. The continuous process of claim 5, wherein the temperature range is from 350° F. to 500° F.

7. The continuous process of claim 5, wherein the temperature range is from 375° F. to 450° F.

8. The continuous process of claim 5, wherein the temperature range is from 395° F. to 425° F.

9. The process according to claim 5 wherein about 1% purified VTAE is combined with about 99% asphalt or bitumen.

10. The process according to claim 5 wherein about 5% purified VTAE is combined with about 95% asphalt or bitumen.

11. The process according to claim 5 wherein about 10% purified VTAE is combined with about 90% asphalt or bitumen.

12. The process according to claim 5 wherein about 20% purified VTAE is combined with about 80% asphalt or bitumen.

13. The process according to claim 5 wherein about 30% purified VTAE is combined with about 70% asphalt or bitumen.

14. The process according to claim 5 wherein about 40% purified VTAE is combined with about 60% asphalt or bitumen.

15. The process according to claim 5 wherein about 50% purified VTAE is combined with about 50% asphalt or bitumen.

16. A method of improving the performance of roofing asphalt comprising purified VTAE and asphalt or bitumen.

17. The method according to claim 16, wherein the blend comprises about 1% purified VTAE and 99% asphalt or bitumen.

18. The method according to claim 16, wherein the blend comprises about 10% purified VTAE and 90% asphalt or bitumen.

19. The method according to claim 16, wherein the blend comprises about 20% purified VTAE and 80% asphalt or bitumen.

20. The method according to claim 16, wherein the blend comprises about 30% purified VTAE and 70% asphalt or bitumen.

21. The method according to claim 16, wherein the blend comprises about 40% purified VTAE and 60% asphalt or bitumen.

22. The method according to claim 16, wherein the blend comprises about 50% purified VTAE and 50% asphalt or bitumen.

23. A method of improving the performance of paving asphalt comprising purified VTAE and asphalt or bitumen.

24. The method according to claim 23, wherein the blend comprises about 1% purified VTAE and 99% asphalt or bitumen.

25. The method according to claim 23, wherein the blend comprises about 10% purified VTAE and 90% asphalt or bitumen.

26. The method according to claim 23, wherein the blend comprises about 20% purified VTAE and 80% asphalt or bitumen.

27. The method according to claim 23, wherein the blend comprises about 30% purified VTAE and 70% asphalt or bitumen.

28. The method according to claim 23, wherein the blend comprises about 40% purified VTAE and 60% asphalt or bitumen.

29. The method according to claim 23, wherein the blend comprises about 50% purified VTAE and 50% asphalt or bitumen.

30. A method of operating an engine turbine with a fuel blend having from about 0.1% to about 99.9% of purified VTAE according to claim 1, the method comprising:
(a) providing a purified VTAE composition
(b) mixing the purified VTAE composition with a natural gas, wherein the mixture provides a fuel oil; and,
(c) utilizing the fuel oil to generate heat or pressure via oxidation to drive an engine or a gas turbine.

31. A composition comprising an improved heavy vacuum gas oil (HVGO) the improvement comprising reduced aging and oxidation of asphaltic materials, wherein the metals selected from the group consisting of aluminum, barium, boron, cadmium, calcium, chromium, copper, iron, lead, molybdenum, manganese, magnesium, nickel, phosphorous, silver, sodium, tin, titanium, vanadium, and zinc are reduced by 80% or better.

32. The composition according to claim 31, wherein the improvement comprising reduced aging and oxidation of asphaltic materials, wherein the metals selected from the group consisting of aluminum, barium, boron, cadmium, calcium, chromium, copper, iron, lead, molybdenum, manganese, magnesium, nickel, phosphorous, silver, sodium, tin, titanium, vanadium, and zinc are reduced by 85% or better.

33. The composition according to claim 31, wherein the improvement comprising reduced aging and oxidation of asphaltic materials, wherein the metals selected from the group consisting of aluminum, barium, boron, cadmium, calcium, chromium, copper, iron, lead, molybdenum, manganese, magnesium, nickel, phosphorous, silver, sodium, tin, titanium, vanadium, and zinc are reduced by 90% or better.

34. The composition according to claim 31, wherein the improvement comprising reduced aging and oxidation of asphaltic materials, wherein the metals selected from the group consisting of aluminum, barium, boron, cadmium, calcium, chromium, copper, iron, lead, molybdenum, manganese, magnesium, nickel, phosphorous, silver, sodium, tin, titanium, vanadium, and zinc are reduced by 95% or better.

35. The composition according to claim 31, wherein the improvement comprising reduced aging and oxidation of asphaltic materials, wherein the metals selected from the group consisting of aluminum, barium, boron, cadmium, calcium, chromium, copper, iron, lead, molybdenum, manganese, magnesium, nickel, phosphorous, silver, sodium, tin, titanium, vanadium, and zinc are reduced below a detectable limit.

36. A fuel blend comprising a composition according to claim 35, wherein the ratio of HVGO to a fuel blending component is in the amount of 1% to 99% by weight.

37. The fuel blend comprising a composition according to claim 36, wherein the ratio of HVGO to fuel blending component is in the amount of 5% to 95% by weight.

38. The fuel blend comprising a composition according to claim 36, wherein the ratio of HVGO to fuel blending component is in the amount of 10% to 90% by weight.

39. The fuel blend comprising a composition according to claim 36, wherein the ratio of HVGO to fuel blending component is in the amount of 20% to 80% by weight.

40. The fuel blend comprising a composition according to claim 36, wherein the ratio of HVGO to fuel blending component is in the amount of 30% to 70% by weight.

41. The fuel blend comprising a composition according to claim 36, wherein the ratio of HVGO to fuel blending component is in the amount of 40% to 60% by weight.

42. The fuel blend comprising a composition according to claim 36, wherein the ratio of HVGO to fuel blending component is in the amount of 50% to 50% by weight.

43. A fuel blend comprising a composition according to claim 31, wherein the ratio of HVGO to fuel blending component is in the amount of 1% to 99% by volume.

44. A fuel blend comprising a composition according to claim 35, wherein the ratio of HVGO to fuel blending component is in the amount of 1% to 99% by volume

45. The fuel blend comprising a composition according to claim 43, wherein the ratio of HVGO to fuel blending component is in the amount of 5% to 95% by volume.

46. The fuel blend comprising a composition according to claim 43, wherein the ratio of HVGO to fuel blending component is in the amount of 10% to 90% by volume.

47. The fuel blend comprising a composition according to claim 43, wherein the ratio of HVGO to fuel blending component is in the amount of 20% to 80% by volume.

48. The fuel blend comprising a composition according to claim 43, wherein the ratio of HVGO to fuel blending component is in the amount of 30% to 70% by volume.

49. The fuel blend comprising a composition according to claim 43, wherein the ratio of HVGO to fuel blending component is in the amount of 40% to 60% by volume.

50. The fuel blend comprising a composition according to claim 43, wherein the ratio of HVGO to fuel blending component is in the amount of 50% to 50% by volume.

51. The fuel blend comprising a composition according to claim 44, wherein the ratio of HVGO to fuel blending component is in the amount of 5% to 95% by volume.

52. The fuel blend comprising a composition according to claim 44, wherein the ratio of HVGO to fuel blending component is in the amount of 10% to 90% by volume.

53. The fuel blend comprising a composition according to claim 44, wherein the ratio of HVGO to fuel blending component is in the amount of 20% to 80% by volume.

54. The fuel blend comprising a composition according to claim 44, wherein the ratio of HVGO to fuel blending component is in the amount of 30% to 70% by volume.

55. The fuel blend comprising a composition according to claim 44, wherein the ratio of HVGO to fuel blending component is in the amount of 40% to 60% by volume.

56. The fuel blend comprising a composition according to claim 44, wherein the ratio of HVGO to fuel blending component is in the amount of 50% to 50% by volume

57. A method of improving the performance of roofing asphalt comprising a blend comprising a HVGO composition wherein the metals selected from the group consisting of aluminum, barium, boron, cadmium, calcium, chromium, copper, iron, lead, molybdenum, manganese, magnesium, nickel, phosphorous, silver, sodium, tin, titanium, vanadium, and zinc are reduced by 80% or better.

58. The method of improving the performance of roofing asphalt according to claim 57 wherein the metals are reduced by 85% or better.

59. The method of improving the performance of roofing asphalt according to claim 57 wherein the metals are reduced by 90% or better.

60. The method of improving the performance of roofing asphalt according to claim 57 wherein the metals are reduced by 95% or better.

61. The method of improving the performance of roofing asphalt according to claim 57 wherein the metals are reduced below a detectable level.

62. A method of operating a marine vessel turbine with a fuel blend having from about 0.1% to about 99.9% of heavy vacuum gas oil according to claim 35, the method comprising:
(a) providing a blend composition comprising a heavy vacuum gas oil and a blend component wherein the blend composition has a sulfur content of less than about 0.05 ppm;
(b) mixing the blend composition with a natural gas, wherein the mixture provides a fuel oil; and,
(c) utilizing the fuel oil to generate heat or pressure to drive an engine or a gas turbine.

63. A method of manufacturing industrial products utilizing a process oil blend having from about 0.1% to about 99% of heavy vacuum gas oil according to claim 35, the method comprising:
(a) providing a heavy vacuum gas oil composition with a low ash content;
(b) mixing the heavy vacuum gas oil composition with a base process oil, wherein the mixtures provides the process oil blend; and,
(c) introducing the process oil blend into an industrial product.

64. A polymer modified asphalt or bitumen formulation comprising:
(a) about 1-98% by weight of a base asphalt or bitumen;
(b) about 1-30% by weight of a VTAE; and,
(c) about 1-30% by weight of at least one or more bituminous modifier selected from the group consisting of atactic polypropylene, styrene-butadiene-sytrene (SBS), styrene-butadiene rubber (SBR), styrene-ethylene-butadiene-sytrene (SEBS), styrene-isoprene-styrene (SIBS), ethylene vinyl acetate, ethylene methacrylate, ethylene butyl acrylate, polyethylene (PE); ethylene glycidyl methacrylate (EGMA) butyl rubber, and mixtures thereof.

65. The polymer modified asphalt or bitumen formulation butadiene according to claim 64, further comprising:
(d) a self-adhesive bituminous material selected from the group consisting of a tackifying resin, pressure sensitive adhesive, and polyvinylbutyral polymer.

66. The polymer modified asphalt or bitumen formulation according to claim 64, further comprising:
(d) a self-adhesive bituminous material selected from the group consisting of a tackifying resin, pressure sensitive adhesive, and polyvinylbutyral polymer; and,
(e) at least one or more mineral filler selected from the group consisting of limestone filler, talc, volcanic ash, graphite, carbon black, silica or china clay, quartz, coal fly ash, kaolin, steel slag, and mixtures thereof.

67. The polymer modified asphalt or bitumen formulation according to 66, wherein the base asphalt or bitumen ranges about 45-95% by weight.

68. The polymer modified asphalt or bitumen formulation according to claim 66, wherein the base asphalt or bitumen ranges about 50-90% by weight.

69. The polymer modified asphalt or bitumen formulation formulation according to claim 66, wherein the base asphalt or bitumen ranges about 60-80% by weight.

70. The polymer modified asphalt or bitumen formulation according to claim 66, wherein the base asphalt or bitumen ranges about 65-75% by weight.

71. The polymer modified asphalt or bitumen formulation according to claim 66, wherein the at least one or more bituminous modifier is selected from the group consisting of styrene-butadiene-styrene (SBS), styrene-ethylene-butadiene-styrene (SEBS), styrene-isoprene-styrene (SIBS), butyl rubber, and mixtures thereof.

72. The polymer modified asphalt or bitumen formulation according to claim 66, wherein the at least one or more bituminous modifier ranges about 1-7% by weight.

73. The polymer modified asphalt or bitumen formulation according to claim 66, wherein the mineral filler is limestone filler.

74. A method of manufacturing a polymer modified asphalt or bitumen formulation comprising:
(a) providing a base asphalt;
(b) admixing VTAE; and
(c) adding at least one or more bituminous modifier.

75. The method of manufacturing a polymer modified asphalt or bitumen formulation according to claim 74 further comprising:
(d) adding a self-adhesive bituminous material.

76. The method of manufacturing a polymer modified asphalt or bitumen formulation according to claim 75 further comprising:
(e) adding a cross-linker.

77. The method of manufacturing a polymer modified asphalt or bitumen formulation according to claim 76, further comprising:
(f) adding a chemical additive, wherein the chemical additive improves adhesion and or compatibility of the bituminous modifier.

78. The method of manufacturing a polymer modified asphalt or bitumen formulation according to claim 77, further comprising:
(g) adding a self-adhesive resin.

79. The method of manufacturing a polymer modified asphalt or bitumen formulation according to claim 78, further comprising:
(h) adding a mineral filler.

80. The method of manufacturing a polymer modified asphalt or bitumen according to claim 79, wherein the bituminous modifier is selected from the group consisting of atactic polypropylene, styrene-butadiene-styrene (SBS), styrene-butadiene rubber (SBR), styrene-ethylene-butadiene-styrene (SEBS), styrene-isoprene-styrene (SIBS), ethylene vinyl acetate, ethylene methacrylate, ethylene butyl acrylate, polyethylene (PE); ethylene glycidyl methacrylate (EGMA), butyl rubber, and mixtures thereof.

81. The method of manufacturing a polymer modified asphalt or bitumen according to claim 79, wherein the bituminous modifier is selected from the group consisting of styrene-butadiene-styrene (SBS), styrene-ethylene-butadiene-styrene (SEBS), styrene-isoprene-styrene (SIBS), butyl rubber, and mixtures thereof.

82. The method of manufacturing a polymer modified asphalt or bitumen according to claim 79, wherein the VTAE is obtained from a continuous purification process.

83. The method of manufacturing a polymer modified asphalt or bitumen according to claim 79, wherein the self-adhesive bituminous material is selected from the group consisting of a tackifying resin, pressure sensitive adhesive, and polyvinylbutyral polymer.

84. The method of manufacturing a polymer modified asphalt or bitumen formulation according to claim 79, wherein the mineral filler is selected from the group consisting of limestone filler, talc, volcanic ash, graphite, carbon black, silica or china clay, quartz, coal fly ash, kaolin, steel slag, and mixtures thereof.

85. The method of manufacturing a polymer modified asphalt or bitumen formulation according to claim 79, wherein the base asphalt is heated to a temperature range of about 100° C. to about 250° C.

86. The method of manufacturing a polymer modified asphalt or bitumen formulation according to claim 79, wherein the VTAE is pre-heated.

87. The method of manufacturing of a polymer modified asphalt or bitumen formulation according to claim 79, wherein the base asphalt is heated to a temperature range of about 135° C. to about 200° C.

88. A method of manufacturing a polymer modified asphalt or bitumen formulation comprising:
(a) providing a VTAE;
(b) adding at least one or more bituminous modifier in a concentration from 1 to 50 weight % to the VTAE, whereby a polymer modified VTAE is formed;
(c) providing a base asphalt;
(d) adding the polymer modified VTAE to the provided base asphalt.

89. The method of manufacturing a polymer modified asphalt or bitumen formulation according to claim 88 further comprising:
(a) providing a VTAE;
(b) adding at least one or more bituminous modifier in a concentration from 1 to 50 weight % to the VTAE, whereby a polymer modified VTAE is formed;
(c) adding a self-adhesive bituminous material;
(d) providing a base asphalt;
(e) adding the polymer modified VTAE to the provided base asphalt.

90. The method of manufacturing a polymer modified asphalt or bitumen formulation according to claim 88 further comprising:
(a) providing a VTAE;
(b) adding at least one or more modifier in a concentration from 1 to 50 weight % to the VTAE, whereby a polymer modified VTAE is formed;
(c) adding a self-adhesive bituminous material;
(d) adding a mineral filler;
(e) providing a base asphalt;
(f) adding the polymer modified VTAE to the provided base asphalt.

91. The method of manufacturing a polymer modified asphalt or bitumen formulation according to claim 88 further comprising:
(a) providing a VTAE;
(b) adding at least one or more bituminous modifier in a concentration from 1 to 50 weight % to the VTAE, whereby a polymer modified VTAE is formed;
(c) providing a base asphalt;
(d) adding the polymer modified VTAE to the provided base asphalt; and,
(e) adding a self-adhesive bituminous material.

92. The method of manufacturing a polymer modified asphalt or bitumen formulation according to claim 88 further comprising:
(a) providing a VTAE;
(b) adding at least one or more bituminous modifier in a concentration from 1 to 50 weight % to the VTAE, whereby a polymer modified VTAE is formed;
(c) providing a base asphalt:
(d) adding the polymer modified VTAE to the provided base asphalt;
(e) adding a self-adhesive bituminous material;
(f) adding a mineral filler.

93. The method of manufacturing a self-adhesive roofing formulation according to claim 92, wherein the bituminous modifier is selected from the group consisting of atactic polypropylene, styrene-butadiene-styrene (SBS), styrene-butadiene rubber (SBR), styrene-ethylene-butadiene-styrene (SEBS), styrene-isoprene-styrene (SIBS), ethylene vinyl acetate, ethylene methacrylate, ethylene butyl acrylate, polyethylene (PE); ethylene glycidyl methacrylate (EGMA), butyl rubber, and mixtures thereof.

94. The method of manufacturing a self-adhesive roofing formulation according to claim 92, wherein the bituminous modifier is selected from the group consisting of styrene-butadiene-styrene (SBS), styrene-ethylene-butadiene-styrene (SEBS), styrene-isoprene-styrene (SIBS), butyl rubber, and mixtures thereof.

95. The method of manufacturing a self-adhesive roofing formulation according to claim 92, wherein the VTAE is obtained from a continuous purification process.

96. The method of manufacturing a self-adhesive roofing formulation according to claim 92, wherein the self-adhesive bituminous material is selected from the group consisting of a tackifying resin, pressure sensitive adhesive, and polyvinylbutyral polymer.

97. The method of manufacturing a self-adhesive roofing formulation according to claim 92, wherein the mineral filler is selected from the group consisting of, limestone filler, talc, volcanic ash, graphite, carbon black, silica or china clay, quartz, coal fly ash, kaolin, steel slag, and mixtures thereof.

98. A method of improving the performance of a polymer modified asphalt or bitumen comprising a composition comprising VTAE, asphalt or bitumen, at least one or more bituminous modifier, a self-adhesive bituminous material, and a mineral filler.

99. The method of improving the performance of a polymer modified asphalt or bitumen according to claim 98, wherein the at least one or more bituminous modifier is selected from the group consisting of atactic polypropylene, styrene-butadiene-sytrene (SBS), styrene-butadiiene rubber (SBR), styrene-ethylene-butadiene-sytrene (SEBS), styrene-isoprene-styrene (SIBS), ethylene vinyl acetate, ethylene methacrylate, ethylene butyl acrylate, polyethylene (PE); ethylene glycidyl methacrylate (EGMA) butyl rubber, and mixtures thereof. In a further aspect, the bituminous modifier comprises at least one modifier comprising styrene-butadiene-styrene (SBS), styrene-ethylene-butadiene-styrene (SEBS), styrene-isoprene-styrene (SIBS), butyl rubber, and mixtures thereof.

100. The method of improving the performance of a polymer modified asphalt or bitumen according to claim 98, wherein the self-adhesive bituminous material is selected from the group consisting of a tackifying resin, pressure sensitive adhesive, and polyvinylbutyral polymer.

101. The method of improving the performance of a polymer modified asphalt or bitumen according to claim 98, wherein the mineral filer is selected from the group consisting of limestone filler, talc, volcanic ash, graphite, carbon black, silica or china clay, quartz, coal fly ash, kaolin, steel slag, and mixtures thereof.

102. The method of improving the performance of a polymer modified asphalt or bitumen according claim 98, wherein the VTAE is obtained from a continuous purification process

103. The method of improving the performance of a polymer modified asphalt or bitumen according to claim 98 wherein the VTAE comprises a composition wherein the metals selected from the group consisting of aluminum, barium, boron, cadmium, calcium, chromium, copper, iron, lead, molybdenum, manganese, magnesium, nickel, phosphorous, silver, sodium, tin, titanium, vanadium, and zinc are below a detectable limit.
